(19) United States
(12) Patent Application Publication
(10) Pub. No.: US 2009/0102351 A1
(43) Pub. Date: Apr. 23, 2009

(54) Image display apparatus

(75) Inventors: Toshiaki Kusunoki, Tokorozawa (JP); Mutsumi Suzuki, Kodaira (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/155,451

(22) Filed: Jun. 4, 2008

(30) Foreign Application Priority Data
Oct. 22, 2007 (JP) JP2007-273554

(51) Int. Cl. H01J 1/62

(52) U.S. Cl. 313/496

(57) ABSTRACT

To realize a large-sized high resolution image display apparatus using an electron emitter array and a phosphor screen, a signal electrode to be formed on the a substrate is made as a thick film, a concave portion is formed in between two signal electrodes, and a convergence electron lens is formed by a base electrode and an top electrode connected to the signal electrode, and thereby electron beams are converged.

### CROSS-REFERENCE TO RELATED APPLICATION

The present application claims priority from Japanese Patent Application No. JP 2007-273554 filed on Oct. 22, 2007, the content of which is hereby incorporated by reference into this application.

### TECHNICAL FIELD OF THE INVENTION

The present invention relates to an image display apparatus, and particularly to an image display apparatus that is also referred as a light-emitting type flat panel display using an electron emitter array and a phosphor screen.

### BACKGROUND OF THE INVENTION

An image display apparatus (field emission display: FED) utilizing a fine and accumulable cold-cathode type electron emitter has been developed. The electron emitters of this kind of an image display apparatus are classified into an electric field discharge type electron emitter and a hot electron type electron emitter. The former includes a spint type electron emitter, a surface conduction type electron emitter, a carbon nano tube type electron emitter and the like, and the latter includes thin film electron emitters such as an MIM (Metal Insulator Metal) type where metal-insulator-metal are laminated, an MIS (Metal Insulator Semiconductor) type where metal-insulator-semiconductor are laminated, and metal-insulator-semiconductor-metal type.

With regard to the MIM type, for example, in Japanese Patent Application Laid-Open Publication No. H07-65710 (Patent Document 1), Japanese Patent Application Laid-Open Publication No. H10-153979 (Patent Document 2), and Japanese Patent Application Laid-Open Publication No. 2002-164006 (Patent Document 3), an MOS type concerning metal-insulator-semiconductor (J. Vac. Sci. Technol. B11 (2) p. 429-432 (1993): Non Patent Document 1), an HEED type concerning metal-insulator-semiconductor-metal type (described in High-efficiency-electron-emission device, Jpn., J., Appl., Phys., Vol. 36, p. 939: Non Patent Document 2 and the like), an EL type (described in Electroluminescence, Applied Physics, volume 63, No. 6, p. 592: Non Patent Document 3 and the like), a porous silicon type (described in Applied Physics, volume 66, No. 5, p. 437: Non Patent Document 4 and the like), have been reported.

Such electron emitters are disposed in plural rows (for example, in the horizontal direction) and in plural columns (for example, in the vertical direction) to form a matrix, and many fluorescent substances disposed to correspond to the respective electron emitters are disposed in vacuum, and thereby an image display apparatus can be structured.

The image display apparatus used for thin-screen television sets and the like have come to be equipped with wide screen, and with the spread of high resolution television sets, further higher resolution is demanded. In realizing these large-sized high resolution displays by FEDs, it is necessary to reduce wiring resistance and improve the wiring delay by CR time constant, the luminance inclination which is generated by voltage decline and the like, and also to converge and extract the electronic beams emitted from the electron emitters, and to make small the beam spot diameter thereof at the moment of emission to a phosphor screen. In particular, in producing a large-sized image display apparatus, its position setting displacement is likely to become large due to heat expansion, heat contraction of the glass in its sealing process, and accordingly, the position setting precision of an electron emitter array substrate and a phosphor screen substrate becomes more critical.

If the ratio of the electronic beam diameter in the horizontal direction to the sub pixel pitch is high, the margin to the position setting displacement becomes small; therefore, the decline of the color purity due to many colors of the electronic beams emitted from the electron emitters is likely to occur. Moreover, since the pitch in the vertical direction is narrow too, if the ratio of the electron beam diameter in the vertical direction to the pixel pitch is high, electronic beams flow into spacers installed on a scan line, and the deflection of the electronic beams are likely to occur due to the charging of the spacers.

Therefore, in the FED, a focusing electrode for converging electronic beams is used. For example, in the MIM (Metal Insulator Metal) type electron emitter, an example in which a focusing (converging) electrode is provided is disclosed in the Patent Document 3.

However, in order to provide the focusing electrode separately, a focusing electrode layer and an interlayer insulator which insulates the same are required, which leads to problems such as the increase of the process costs, and material costs, and the decline of the yield due to the increase of processes. Therefore, there is a demand for a focusing structure with fewer processes and a high yield. Moreover, in creating a large-sized display, since the pollution probability due to foreign matters and the like increases, it is necessary to structure a process strong against contamination.

### SUMMARY OF THE INVENTION

An object of the present invention is to provide a structure of an electron emitter array for solving the above subject at the time of producing these large-sized and high definition image display apparatuses.

The above object can be realized by utilizing thick signal electrodes (so-called “thick film electrodes”) which are formed for reducing wiring resistance of a large-sized image display apparatus and scan electrodes for convergence of the electronic beams. In concrete, it is realized by disposing the electron emitter on a concave bottom which is held or surrounded from two to four sides by the thick signal electrode formed on an insulating substrate. Moreover, it is realized more effectively by arranging the electron emitter on the concave bottom in which a concave bottom surrounded by the thick signal electrode is surrounded doubly by a thick signal electrode which is insulated from the signal electrode in the interlayer insulator with the thick scan electrode further insulated therewith.

Herein, the electron emitter is the one which emits electrons by applying a voltage between two thin film electrodes that are thinner than the signal electrode and the scan electrode connected to the thick signal electrode and the scan electrode which is insulated by the interlayer insulator respectively. In particular, it is preferable to form the two thin film electrodes by separately processing a same metal film formed on the upper layer than the signal electrode and the scan electrode in respect of the improvement of the yield and the securement of reliability.

The electron emitter can be realized by laminating an electron acceleration layer in which an insulator, a semiconductor layer and the like are laminated on one of the two thin film electrodes, or an electron acceleration layer in which the surface of the thin film electrode is oxidized, and an electron emission electrode on the other thin film electrode connected to the scan electrode.

According to the methods to achieve the above object, the signal electrode forms a concave foundation form by surrounding the electron acceleration layer, and the concave electron emission electrode which covers the interlayer insulator laminated thereon modulates an anode electric field to form an electron lens; therefore it is possible to have a function to focus the electron beams. At this time, by disposing the electron emitter on the concave bottom held from at least two sides by the thick signal electrode which runs in the vertical direction, the electron beam diameter in the horizontal direction is squeezed, and accordingly it is possible to prevent mixed colors. Moreover, by placing the electron emitter on the concave bottom held or surrounded from four sides in the horizontal direction by the signal electrode, it is possible to squeeze not only the electron beam diameter in the horizontal direction (the scan electrode direction) but also the electron beam diameter in the vertical direction (the signal electrode direction), and accordingly it is possible to suppress the electrons from flowing into the spacer disposed on the scan electrode to suppress charging of the spacer.

According to this structure, it is possible to form a structure which focuses the electron beams without using the exclusive focusing electrodes other than the signal electrode required for driving of the electron emitter and the scan electrode.

Further, the other thin film electrode connected to the signal electrode and the scan electrode is used as a contact electrode which assumes the electrical connection between the base electrode of the electron emitter and the electron emission electrode, and is made into the optimal film thickness for creating the electron emitter; thereby, the restrictions of the film thickness for the signal electrode and the scan electrode are eliminated, and it becomes easy to set to a film thickness with high focusing performance. Moreover, by creating the electron emitter onto the thin film electrode formed after the processing of the signal electrode and the scan electrode, it is possible to realize a structure in which the electron emitter is not subject to damages or contamination in the process, and also to realize a high yield.

### BRIEF DESCRIPTIONS OF THE DRAWINGS

FIG. 1 is a schematic top plan view for explaining the first embodiment of the present invention, in which a image display apparatus using the MIM type electron emitter is taken as an example;

FIG. 2 is a drawing showing the operating principle of the thin film or MIM type electron emitter;

FIG. 3A is a drawing (schematic top plan view) showing a manufacturing method of a thin film electron emitter according to the first embodiment of the present invention;

FIG. 3B is a cross section along line A-A′ of FIG. 3A;

FIG. 3C is a cross section along line B-B′ of FIG. 3A;

FIG. 4A is a drawing following the figure showing a manufacturing method of a thin film electron emitter according to the first embodiment of the present invention;

FIG. 4B is a cross section along line A-A′ of FIG. 4A;

FIG. 4C is a cross section along line B-B′ of FIG. 4A;

FIG. 5A is a drawing following FIGS. 4A-4C showing a manufacturing method of a thin film electron emitter according to the first embodiment of the present invention;

FIG. 5B is a cross section along line A-A′ of FIG. 5A;

FIG. 5C is a cross section along line B-B′ of FIG. 5A;

FIG. 6A is a drawing following FIGS. 5A-5C showing a manufacturing method of a thin film electron emitter according to the first embodiment of the present invention;

FIG. 6B is a cross section along line A-A′ of FIG. 6A;

FIG. 6C is a cross section along line B-B′ of FIG. 6A;

FIG. 7A is a drawing following FIGS. 6A-6C showing a manufacturing method of a thin film electron emitter according to the first embodiment of the present invention;

FIG. 7B is a cross section along line A-A′ of FIG. 7A;

FIG. 7C is a cross section along line B-B′ of FIG. 7A;

FIG. 8A is a drawing following FIGS. 7A-7C showing a manufacturing method of a thin film electron emitter according to the first embodiment of the present invention;

FIG. 8B is a cross section along line A-A′ of FIG. 8A;

FIG. 8C is a cross section along line B-B′ of FIG. 8A;

FIG. 9A is a drawing following FIGS. 8A-8C showing a manufacturing method of a thin film electron emitter according to the first embodiment of the present invention;

FIG. 9B is a cross section along line A-A′ of FIG. 9A;

FIG. 9C is a cross section along line B-B′ of FIG. 9A;

FIG. 10A is a drawing following FIGS. 9A-9C showing a manufacturing method of a thin film electron emitter according to the first embodiment of the present invention;

FIG. 10B is a cross section along line A-A′ of FIG. 10A;

FIG. 10C is a cross section along line B-B′ of FIG. 10A;

FIG. 11A is a drawing following FIGS. 10A-10C showing a manufacturing method of a thin film electron emitter according to the first embodiment of the present invention;

FIG. 11B is a cross section along line A-A′ of FIG. 11A;

FIG. 11C is a cross section along line B-B′ of FIG. 11A;

FIG. 12A is a drawing following FIGS. 11A-11C showing a manufacturing method of a thin film electron emitter according to the first embodiment of the present invention;

FIG. 13A is a drawing following FIGS. 12A-12C showing a manufacturing method of a thin film electron emitter according to the first embodiment of the present invention;

FIG. 13B is a cross section along line A-A′ of FIG. 13A;

FIG. 13C is a cross section along line B-B′ of FIG. 13A;

FIG. 14A is a drawing following FIGS. 13A-13C showing a manufacturing method of a thin film electron emitter according to the first embodiment of the present invention;

FIG. 14B is a cross section along line A-A′ of FIG. 14A;

FIG. 14C is a cross section along line B-B′ of FIG. 14A;

FIG. 15A is a drawing following FIGS. 14A-14C showing a manufacturing method of a thin film electron emitter according to the first embodiment of the present invention;

FIG. 15B is a cross section along line A-A′ of FIG. 15A;

FIG. 15C is a cross section along line B-B′ of FIG. 15A;

FIG. 16 is a cross section schematically showing an electron lens of an electron emitter of the first embodiment of the present invention;

FIG. 17A is a drawing following FIGS. 3A-3C showing a manufacturing method of a thin film electron emitter according to a second embodiment of the present invention;

FIG. 17B is a cross section along line A-A′ of FIG. 17A;

FIG. 17C is a cross section along line B-B′ of FIG. 17A;

FIG. 18A is a drawing following FIGS. 17A-17C showing a manufacturing method of a thin film electron emitter according to the second embodiment of the present invention;

FIG. 18B is a cross section along line A-A′ of FIG. 18A;

FIG. 18C is a cross section along line B-B′ of FIG. 18A;

FIG. 19A is a drawing following FIGS. 18A-18C showing a manufacturing method of a thin film electron emitter according to the second embodiment of the present invention;

FIG. 20A is a drawing following FIGS. 19A-19C showing a manufacturing method of a thin film electron emitter according to the second embodiment of the present invention;

FIG. 20B is a cross section along line A-A′ of FIG. 20A;

FIG. 20C is a cross section along line B-B′ of FIG. 20A;

FIG. 21A is a drawing following FIGS. 20A-20C showing a manufacturing method of a thin film electron emitter according to the second embodiment of the present invention;

FIG. 21B is a cross section along line A-A′ of FIG. 21A;

FIG. 21C is a cross section along line B-B′ of FIG. 21A;

FIG. 22A is a drawing following FIGS. 21A-21C showing a manufacturing method of a thin film electron emitter according to the second embodiment of the present invention;

FIG. 22B is a cross section along line A-A′ of FIG. 22A;

FIG. 22C is a cross section along line B-B′ of FIG. 22A;

FIG. 23A is a drawing following FIGS. 22A-22C showing a manufacturing method of a thin film electron emitter according to the second embodiment of the present invention;

FIG. 23B is a cross section along line A-A′ of FIG. 23A;

FIG. 23C is a cross section along line B-B′ of FIG. 23A;

FIG. 24A is a drawing following FIGS. 23A-23C showing a manufacturing method of a thin film electron emitter according to the second embodiment of the present invention;

FIG. 24B is a cross section along line A-A′ of FIG. 24A;

FIG. 24C is a cross section along line B-B′ of FIG. 24A;

FIG. 25A is a drawing following FIGS. 24A-24C showing a manufacturing method of a thin film electron emitter according to the second embodiment of the present invention;

FIG. 25B is a cross section along line A-A′ of FIG. 25A;

FIG. 25C is a cross section along line B-B′ of FIG. 25A;

FIG. 26A is a drawing following FIGS. 25A-25C showing a manufacturing method of a thin film electron emitter according to the second embodiment of the present invention;

FIG. 26B is a cross section along line A-A′ of FIG. 26A;

FIG. 26C is a cross section along line B-B′ of FIG. 26A;

FIG. 27A is a drawing following FIGS. 26A-26C showing a manufacturing method of a thin film electron emitter according to the second embodiment of the present invention;

FIG. 27B is a cross section along line A-A′ of FIG. 27A;

FIG. 27C is a cross section along line B-B′ of FIG. 27A;

FIG. 28A is a drawing following FIGS. 27A-27C showing a manufacturing method of a thin film electron emitter according to the second embodiment of the present invention;

FIG. 28B is a cross section along line A-A′ of FIG. 28A;

FIG. 28C is a cross section along line B-B′ of FIG. 28A;

FIG. 29A is a cross section taken along a scan electrode direction, which schematically shows an electron lens of an electron emitter of the second embodiment of the present invention;

FIG. 29B is a cross section taken along a signal electrode direction, which schematically shows an electron lens of an electron emitter of the second embodiment of the present invention;

FIG. 30A is a drawing following FIGS. 3A-3C showing a manufacturing method of a thin film electron emitter according to a third embodiment of the present invention;

FIG. 30B is a cross section along line A-A′ of FIG. 30A;

FIG. 30C is a cross section along line B-B′ of FIG. 30A;

FIG. 31A is a drawing following FIGS. 30A-30C showing a manufacturing method of a thin film electron emitter according to the third embodiment of the present invention;

FIG. 31B is a cross section along line A-A′ of FIG. 31A;

FIG. 31C is a cross section along line B-B′ of FIG. 31A;

FIG. 32A is a drawing following FIGS. 31A-31C showing a manufacturing method of a thin film electron emitter according to the third embodiment of the present invention;

FIG. 32B is a cross section along line A-A′ of FIG. 32A;

FIG. 32C is a cross section along line B-B′ of FIG. 32A;

FIG. 33A is a drawing following FIGS. 32A-32C showing a manufacturing method of a thin film electron emitter according to the third embodiment of the present invention;

FIG. 33B is a cross section along line A-A′ of FIG. 33A;

FIG. 33C is a cross section along line B-B′ of FIG. 33A;

FIG. 34A is a drawing following FIGS. 33A-33C showing a manufacturing method of a thin film electron emitter according to the third embodiment of the present invention;

FIG. 34B is a cross section along line A-A′ of FIG. 34A;

FIG. 34C is a cross section along line B-B′ of FIG. 34A;

FIG. 35A is a drawing following FIGS. 34A-34C showing a manufacturing method of a thin film electron emitter according to the third embodiment of the present invention;

FIG. 35B is a cross section along line A-A′ of FIG. 35A;

FIG. 35C is a cross section along line B-B′ of FIG. 35A;

FIG. 36A is a drawing following FIGS. 35A-35C showing a manufacturing method of a thin film electron emitter according to the third embodiment of the present invention;

FIG. 36B is a cross section along line A-A′ of FIG. 36A;

FIG. 36C is a cross section along line B-B′ of FIG. 36A;

FIG. 37A is a drawing following FIGS. 36A-36C showing a manufacturing method of a thin film electron emitter according to the third embodiment of the present invention;

FIG. 37B is a cross section along line A-A′ of FIG. 37A;

FIG. 37C is a cross section along line B-B′ of FIG. 37A;

FIG. 38A is a drawing following FIGS. 37A-37C showing a manufacturing method of a thin film electron emitter according to the third embodiment of the present invention;

FIG. 38B is a cross section along line A-A′ of FIG. 38A;

FIG. 38C is a cross section along line B-B′ of FIG. 38A;

FIG. 39A is a drawing following FIGS. 38A-38C showing a manufacturing method of a thin film electron emitter according to the third embodiment of the present invention;

FIG. 39B is a cross section along line A-A′ of FIG. 39A;

FIG. 39C is a cross section along line B-B′ of FIG. 39A;

FIG. 40 is a cross section which schematically shows an electron lens of an electron emitter according to the third embodiment of the present invention;

FIG. 41A is a drawing following FIGS. 32A-32C showing a manufacturing method of a thin film electron emitter according to a fourth embodiment of the present invention;

FIG. 41B is a cross section along line A-A′ of FIG. 41A;

FIG. 41C is a cross section along line B-B′ of FIG. 41A;

FIG. 42A is a drawing following FIGS. 41A-41C showing a manufacturing method of a thin film electron emitter according to the fourth embodiment of the present invention;

FIG. 42B is a cross section along line A-A′ of FIG. 42A;

FIG. 42C is a cross section along line B-B′ of FIG. 42A;

FIG. 43A is a drawing following FIGS. 42A-42C showing a manufacturing method of a thin film electron emitter according to the fourth embodiment of the present invention;

FIG. 43B is a cross section along line A-A′ of FIG. 43A;

FIG. 43C is a cross section along line B-B′ of FIG. 43A;

FIG. 44A is a drawing following FIGS. 43A-43C showing a manufacturing method of a thin film electron emitter according to the fourth embodiment of the present invention;

FIG. 44B is a cross section along line A-A′ of FIG. 44A;

FIG. 44C is a cross section along line B-B′ of FIG. 44A;

FIG. 45A is a drawing following FIGS. 44A-44C showing a manufacturing method of a thin film electron emitter according to the fourth embodiment of the present invention;

FIG. 45B is a cross section along line A-A′ of FIG. 45A;

FIG. 45C is a cross section along line B-B′ of FIG. 45A;

FIG. 46A is a drawing following FIGS. 45A-45C showing a manufacturing method of a thin film electron emitter according to the fourth embodiment of the present invention;

FIG. 46B is a cross section along line A-A′ of FIG. 46A;

FIG. 46C is a cross section along line B-B′ of FIG. 46A;

FIG. 47A is a drawing following FIGS. 46A-46C showing a manufacturing method of a thin film electron emitter according to the fourth embodiment of the present invention;

FIG. 47B is a cross section along line A-A′ of FIG. 47A;

FIG. 47C is a cross section along line B-B′ of FIG. 47A;

FIG. 48A is a drawing following FIGS. 31A-31C showing a manufacturing method of a thin film electron emitter according to a fifth embodiment of the present invention;

FIG. 48B is a cross section along line A-A′ of FIG. 48A;

FIG. 48C is a cross section along line B-B′ of FIG. 48A;

FIG. 49A is a drawing following FIGS. 48A-48C showing a manufacturing method of a thin film electron emitter according to the fifth embodiment of the present invention;

FIG. 49B is a cross section along line A-A′ of FIG. 49A;

FIG. 49C is a cross section along line B-B′ of FIG. 49A;

FIG. 50 is a cross section which schematically shows an electron lens of an electron emitter of fourth and fifth embodiments of the present invention; and

FIG. 51 is a graph showing the focusing performance of the electron beams of an image display apparatus according to the present invention.

### DESCRIPTIONS OF THE PREFERRED EMBODIMENTS

Hereinafter, the best mode of the present invention is explained in detail with reference to the attached drawings of an embodiment. First, a first embodiment of an image display apparatus according to the present invention is explained with an image display apparatus using the MIM type electron emitter as an example.

### First Embodiment

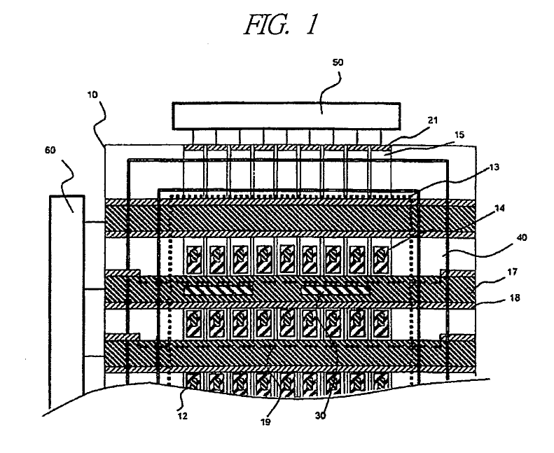

FIG. 1 is a drawing for explaining the first embodiment of the present invention, and it is a schematic top plan view showing an image display apparatus using the MIM type electron emitter as an example. Meanwhile, in FIG. 1, the top plan of one substrate (electron emitter array substrate) 10 having electron emitters and a frame glass 40 are mainly shown, and the other substrate (phosphor substrate) in which phosphors are formed is omitted in illustration.

On the electron emitter array substrate 10, there are formed a signal electrode 21 connected to a signal line drive circuit 50, an interlayer insulator 15 which insulates the signal electrode 21 and a scan electrode 17, the scan electrode 17 connected with a scan line drive circuit 60 and disposed perpendicularly to the signal electrode 21, a contact electrode 18 laminated on the scan electrode 17 for connecting a top electrode 13, a step structure 19 for separating the top electrode 13 for each scan electrode, an electron acceleration layer 12 formed by oxidizing the surface of a base electrode of the electron emitter formed on the substrate of the opening of the signal electrode 21 by processing the same film as that of the contact electrode 18, a field insulator 14, and other functional films to be mentioned later.

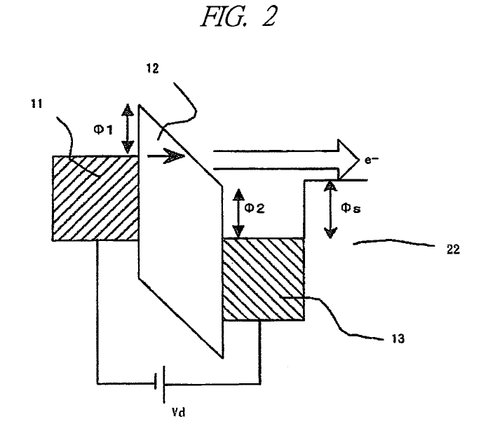

FIG. 2 is an explanatory diagram of the principle of the MIM type electron emitter. The MIM type electron emitter applies a drive voltage Vd between the top electrode 13 and the base electrode 11, and makes the electric field in the electron acceleration layer 12 into about 1 to 10 MV/cm, then the electrons near the Fermi level in the base electrode 11 penetrate a barrier by a tunnel phenomenon, and are injected into the conducting zone of the electron acceleration layer 12. After that, the electrons become hot electrons to flow into the conducting zone of the top electrode 13. Among these hot electrons, those that reach the surface of the top electrode 13 with an energy equal to or more than a workfunction φs of the top electrode 13 are emitted into vacuum 22.

Returning to FIG. 1, spacers 30 are disposed on the scan electrode 17 of the electron emitter array substrate 10 so as to be under a black matrix (not shown) of a phosphor screen substrate. The frame glass 40 is adhered to the electron emitter array substrate 10 and the phosphor screen substrate (not shown) by a flit glass, and the inside thereof is exhausted to vacuum.

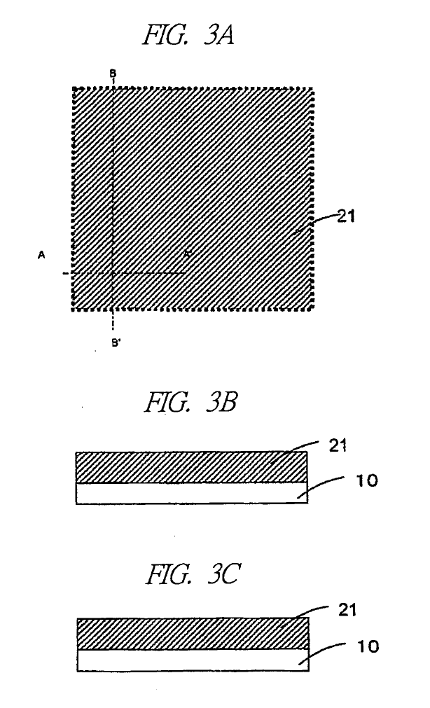

Hereinafter, the first embodiment of the electron emitter array in which the electron emitter having an electron emission portion in a position lower than the height of the signal electrodes is disposed on the concave bottom held by two thick signal electrodes is explained with the MIM type thin film electron emitter as an example with reference to FIG. 3 to FIG. 16.

First, as shown in FIGS. 3A-3C, a metal film for the signal electrode 21 is formed on the glass substrate 10. Here, an alloy in which two atomic weight % of neodymium Nd is doped into aluminum Al (Al—Nd alloy) is used. For this film formation, for example, a sputtering method is used. When the film thickness is set to, for example, 2 μm, the metal film 21 for the signal electrodes of low resistance around 20 mΩ/□ can be formed. By adding impurity elements such as neodymium Nd, Sm, Y, Sc, Ta, Ti, Zr, Hf, and Nb, it is effective to suppress the hillock of Al wiring.

When pure Al is sputtered and used in place of the Al—Nd alloy, although the hillock resistance decreases, the film stress is small and problems such as exfoliation do not occur. Accordingly, it is possible to make the metal film further for the signal electrode 21 thicker (4 to 6 μm). Thereby, it is further possible to realize further lower resistance (6 to 8 mΩ/□). Moreover, since the signal electrode 21 and the base electrode 11 which forms the electron acceleration layer 12 are formed of different films as described below, even when the electron acceleration layer 12 is made by anodization of Al, it is not always necessary to use an Al system material for the signal electrode 21, but a thick photosensitive Ag paste printing film (4 to 8 μm) and the like may be used. In that case, it is possible to achieve further lower resistance (2 to 6 mΩ/□). In the case where these materials are used for the signal electrode 21, the interlayer insulator 15 mentioned later is formed thicker than the case where the Al alloy is used for the signal electrode, in order to prevent the hillock and the diffusion of Ag.

Forming the metal film for signal electrode 21 into a thick film in this manner has the effect to reduce wiring resistance and solve the signal delay caused by the CR at a time constant, as well as increase the electron lens effect utilizing the concave and convex of the signal electrode 21 as described below.

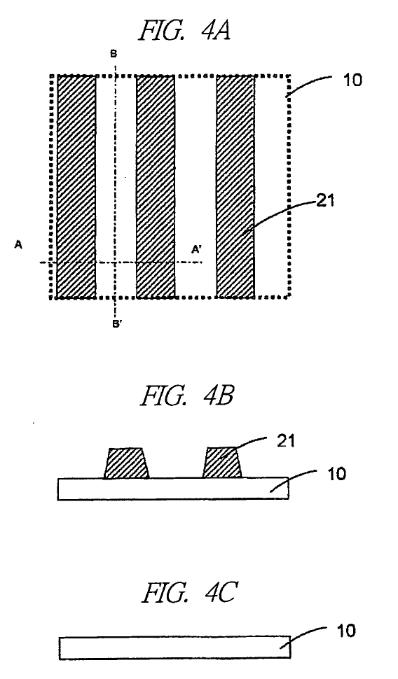

After the film formation of the Al—Nd alloy or the pure Al film, the line-shaped signal electrode 21 is formed by the patterning process, and an etching process of photo resist (FIGS. 4A-4C). As for the etching solution, wet etching in the mixed aqueous solution of phosphoric acid, acetic acid, and nitric acid may be used. Although the electrode width of the signal electrode 21 is different depending on the sizes and resolutions of the image display apparatus, it is set to about the half of the pitch of the sub pixel, approximately 50 to 100 microns.

The electron emitter described below is formed in the gap part between these two signal electrodes 21. On the surface of the thick signal electrode 21, crystal grains tend to grow and generally the flatness is deteriorated, but in the present embodiment, it becomes unnecessary to form the electron emitter on the thick signal electrode 21, and it is possible to form the base electrode 11 of the electron emitter directly on the insulator 15 and the glass substrate 10 with better flatness in a process described below. Moreover, when the thick signal electrode 21 is formed so as to hold or squeeze the electron emission portion from left and right in the horizontal direction (scan electrode direction, A-A′ direction), it becomes the foundation on which the concave electron lens for converging the diameter of the electron beam in the horizontal direction. In the case where the photosensitive Ag paste printing film is used, the photosensitive paste itself is exposed (negative) and developed, and processed into the shape of the signal electrode 21.

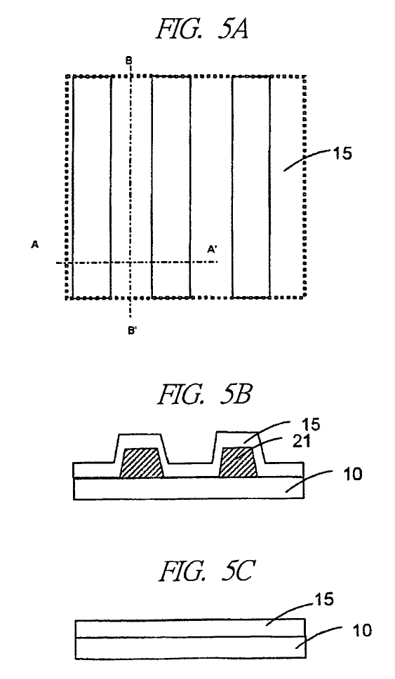

Next, an insulation film used as the interlayer insulator 15 is formed by, for example, the sputtering method or the printing method (FIGS. 5A-5C). As the interlayer insulator 15 formed by the sputtering method, for example, a silicone oxide, a silicon nitride film, a laminated film of these and the like may be used, and particularly, it is effective in the case where the high hillock resistance Al alloy is used for the signal electrode. On the other hand, meanwhile, in the case of forming the interlayer insulator by the printing method, it is possible to use a dielectric film which is made of oxides such as Zn, Bi, Ti, B, Al, Si and the like, alkaline metals, and alkaline earth metal oxides may be employed. In addition, an applied or paint type insulation film, for example, SOD (Spin On Dielectric) such as SiOC, poly silazane and the like may be used too. Since the interlayer insulator 15 using the printing method can be formed thick, it is effective particularly when the pure Al and the photosensitive Ag paste are used for the signal electrode 21.

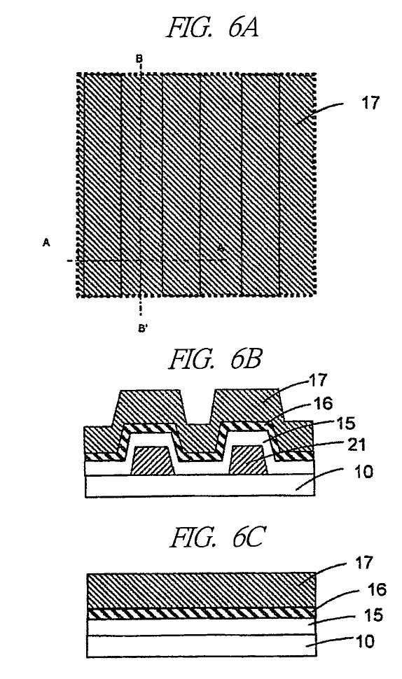

Next, the thick scan electrode 17 is formed. Herein, the scan electrode 17 with the step separation structure 19 for separating the top electrode 13 to be formed later in a self-aligning manner at the time of sputtering is formed. First, a laminated film of a metal film to become the isolation layer 16 and a metal film to become the scan electrode 17 is formed by sputtering (FIGS. 6A-6C). Herein, an Mo—Cr alloy in which 5 at % of Cr is added to Mo is used as the isolation layer 16, and pure Al with a low specific resistance is used as the scan electrode 17. As the isolation layer, a Mo—Cr—Ni alloy and the like may be used too. The film thicknesses thereof are 100 nm and 6 μm respectively. Thereby, low resistance wiring of 6 mΩ/□ can be realized. Furthermore, in order to achieve low resistance, the scan electrode 17 in which the above sputtered film is laminated on a screen printing wiring such as Ag may be used, and in the case where Ag printing wiring of film thickness 10 μm and the spattered film are laminated, it is possible to realize low resistance wiring of 1 to 2 mΩ/□.

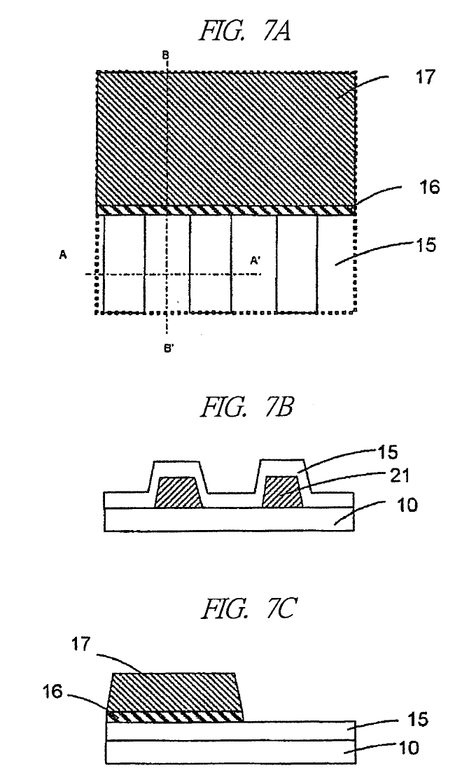

Next, the processings of the scan electrode 17 and the isolation layer 16 are performed (FIGS. 7A-7C). Bulk etching is possible by using wet etching with the mixed aqueous solution of, for example, phosphoric acid, acetic acid, and nitric acid.

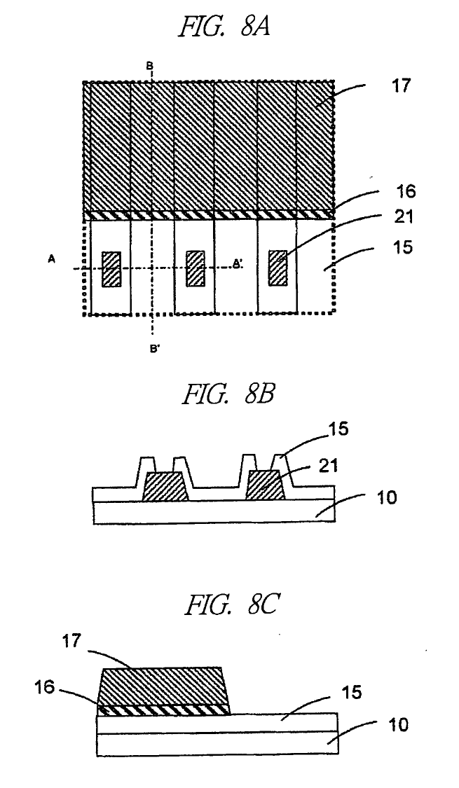

Next, a part of the interlayer insulator 15 on the signal electrode 21 is removed by dry etching to form a through hole. The etching may be performed by dry etching using the etching gas which is made mainly of, for example, CF₄ and SF₆ (FIGS. 8A-8C). In the case where the dielectric glass is used, it is also possible to perform the wet etching by nitric acid and the like to make an opening.

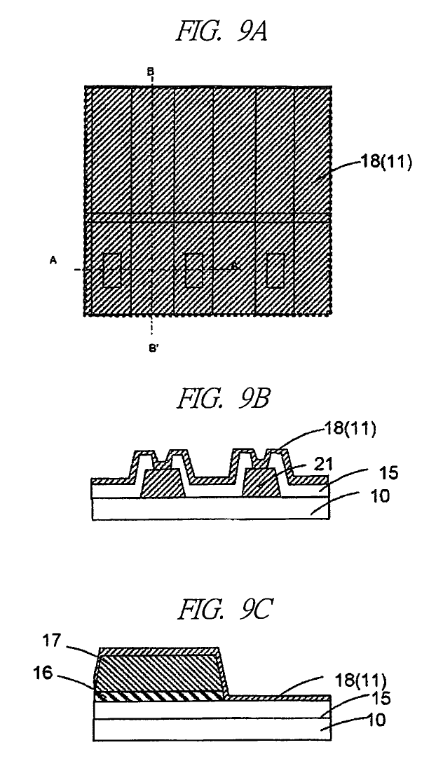

Then, a metal film for the contact electrodes 18 used as the portion which electrically connects the scan electrode 17 and the top electrode 13, and a metal film used as the base electrode 11 of the electron emitter are formed by sputtering (FIGS. 9A-9C). Here, by using an Al—Nd alloy in which 0.6 atom weight % of Rd is doped, the sputtering method is formed. Since this electrode should just have a function as the contact electrode 18 and the base electrode 11, different from the electric supply lines such as the signal electrode 21 and the scan electrode 17, it does not need to be low resistance. Therefore, the film thickness may be a thin film that has high flatness, and is easy for the taper processing of the contact electrode 18, and for example, it may be sufficient at 300 nm or less. Since the flatness of the surface of an Al—Nd alloy film around 300 nm is preferable. In addition, since its volume is small, the hillock resistance is high too. Therefore, it is possible to lower the Nd concentration added in order to suppress the hillock. Thereby, it is possible to lower the Nd concentration in the electron acceleration layer that is formed by anodization of the base electrode 11 described below, and it is possible to form the electron acceleration layer 12 with low trap density, and it is effective in displaying pictures with few afterimages in the case of use as the image display apparatus. Moreover, in the case of the wet etching by the mixed aqueous solution of phosphor acid, acetic acid, and nitric acid, even when taper etching is performed by increasing the nitric acid ratio and retreating the resist, since the etching time is short and an excessive damage is not given to the resist, the controllability is preferable.

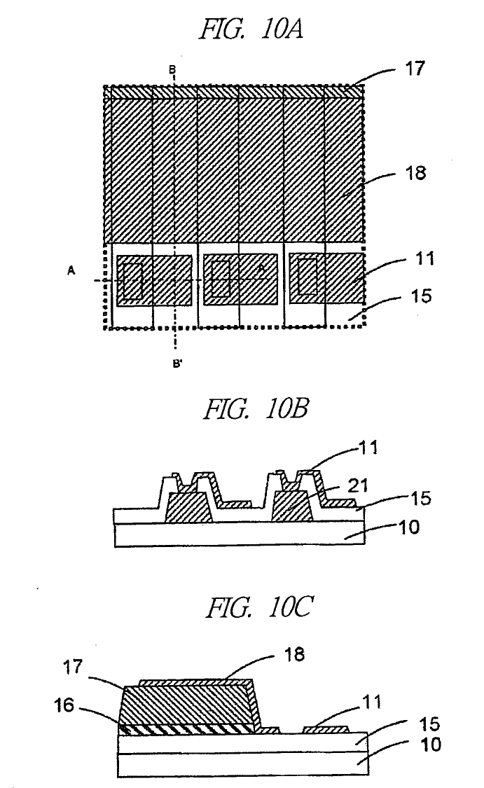

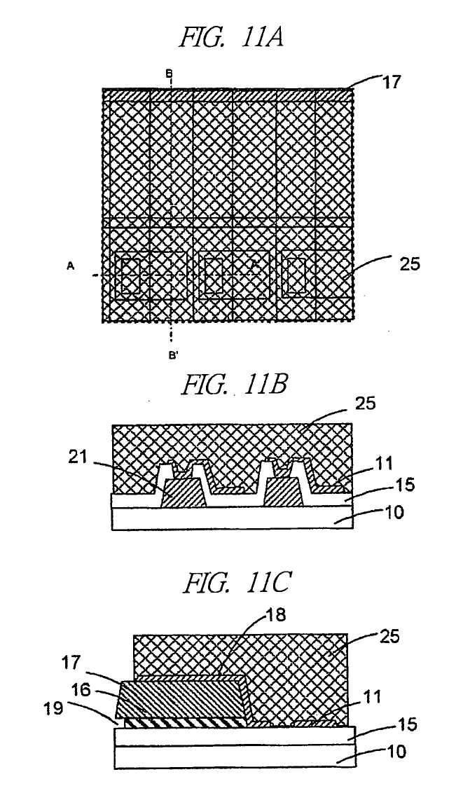

Then, the processings of the contact electrode 18 and the base electrode 11 are performed (FIGS. 10A-10C). In order to perform taper-processing to the contact electrode 18 and the lower electrode 11, the wet etching using the mixed aqueous solution of phosphor acid, acetic acid, and nitric acid as for the etching solution is performed. By increasing the ratio of nitric acid, the resist retreat during the etching can be promoted, and the processed end surface can be finished in a tapered shape. Subsequently, other portions than the portion in which the step structure 19 is formed are covered with the resist 25, and the isolation layer 16 is etched by the wet etching of nitric acid ammonium cerium aqueous solution, and the step structure 19 is formed (FIGS. 11A-11C).

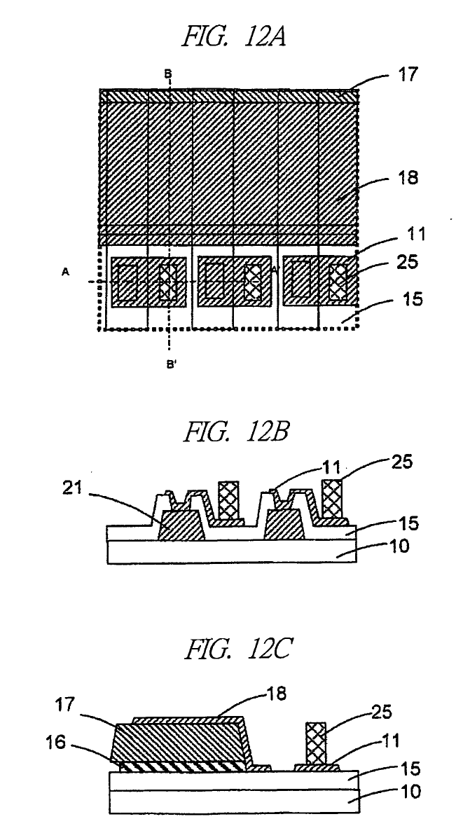

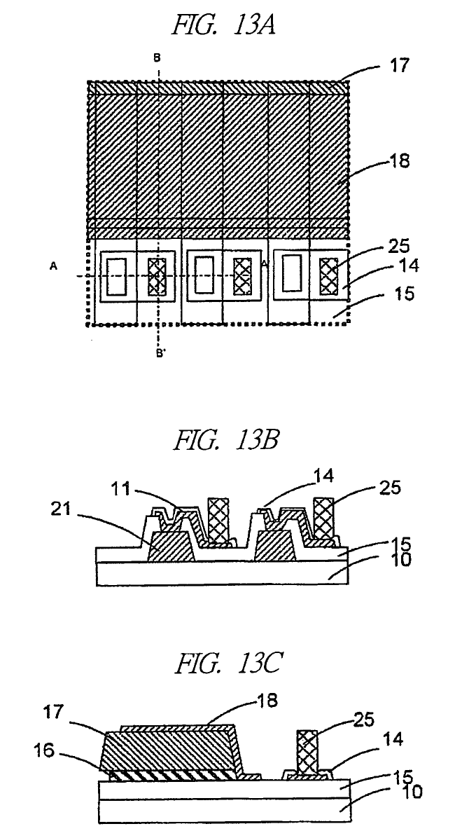

Then, the portion to become an electron emission portion on the base electrode 11 is covered with the resist 25 (FIGS. 12A-12C), and the circumference around it is anodized thickly (FIGS. 13A-13C). By setting the chemical conversion voltage to 200V, it is possible to form the field insulator 14 of 280 nm.

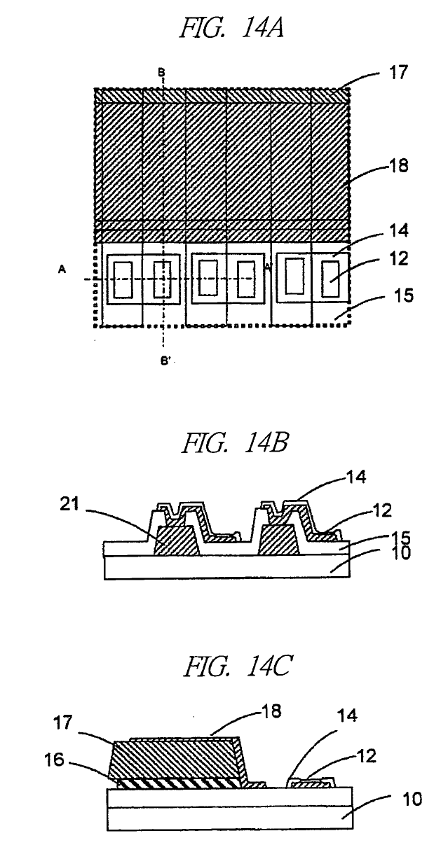

Then, the resist is removed or exfoliated, and the electron acceleration layer 12 is formed in the electron emission portion (FIGS. 14A-14C). By setting the chemical conversion voltage to 4V, it is possible to form the electron acceleration layer 12 of about 10 nm. Although the surface of the base electrode 11 is oxidized to form the electron acceleration layer in the present embodiment, it is also possible to form this process by the method of laminating an insulation film and a semiconductor film.

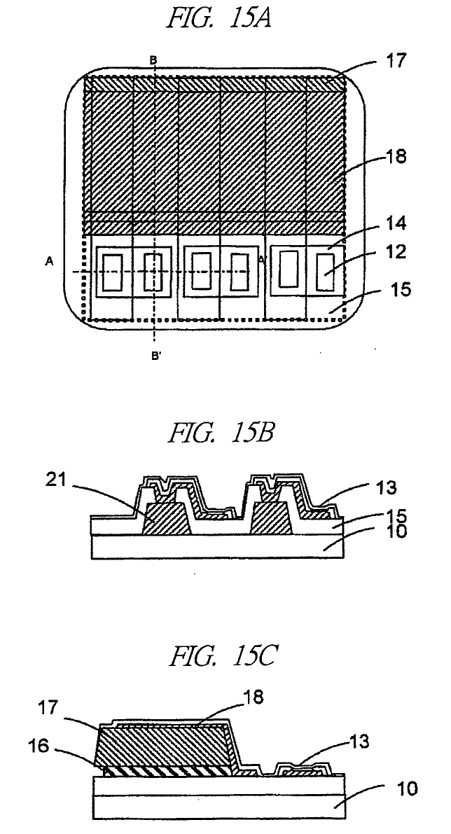

Thereafter, the film formation of the top electrode 13 film is performed by the sputtering method and the like. As the top electrode 13, the platinum group of family 8, and the precious or noble metals of family 1b with high transmissivity of hot electrons are effective. In particular, Pd, Pt, Rh, Ir, Ru, Os, Au, Ag, and a laminated film of these metals and the like are effective. Here, a laminated film of, for example, Ir, Pt, and Au is used, the film thickness ratio is set to 1:3:3, and the film thickness is set to, for example, 3 nm (FIGS. 15A-15C).

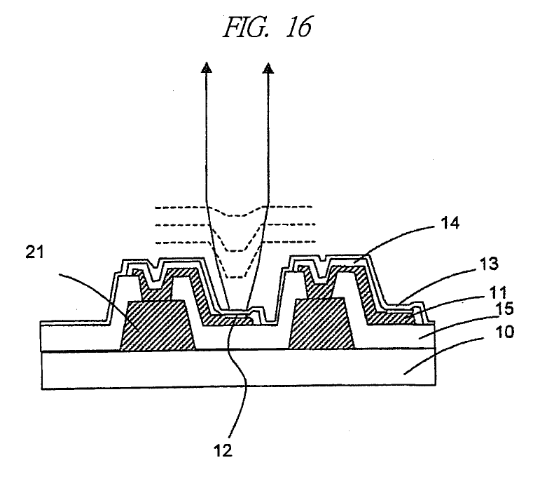

By using the present embodiment, it is possible to form the electron lens having a concave equipotential surface on the electron acceleration layer by making the form in which the electron acceleration layer 12 is held from left and right by the step of the thick signal electrode 21 without using the interlayer insulator and the like for insulating the focusing electrode and the focusing electrode for exclusive use. Then, the focusing performance of the electron beams to be emitted in the horizontal direction (the scan line direction, the A-A′ direction) can be improved, and the emission of multi colors can be prevented; therefore a high definition image display apparatus can be realized. The state where the anode electric field is modulated by the electron emitter of the present invention, and the orbit of the electron beams are schematically shown in FIG. 16.

Moreover, by forming the thick signal electrode 21 and the scan electrode 17 by the films different from the base electrode 11 which forms the electron emitter and the contact electrode 18 which connects to the top electrode 13, it is possible to realize them without deteriorating the surface flatness and the hillock resistance of the base electrode 11 which forms the electron emitter, and without disconnecting the thin top electrode 13.

Moreover, unlike the case to anodize the surface of the signal electrode 21 which serves as the base electrode 11 to form the electron acceleration layer 12 in the prior art, after the processing of the signal electrode 21, the interlayer insulator 15, the scan electrode 17 and the like is finished, and it is possible to minimize the damages and contamination in the electron emitter creation process in order to produce the electron acceleration layer 12.

### Second Embodiment

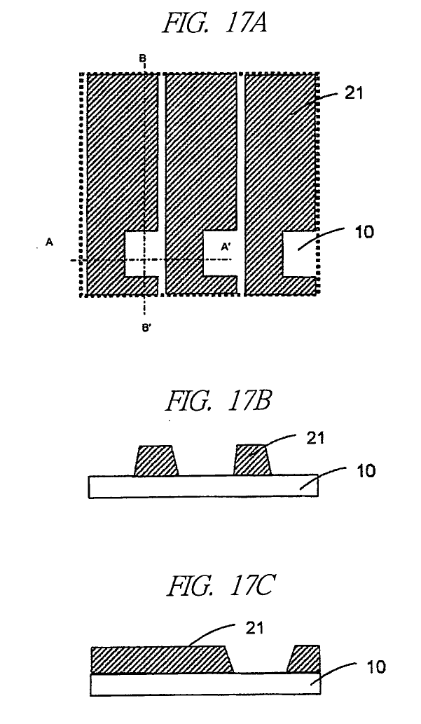

Hereinafter, a second embodiment of an electron emitter array in which an electron emitter having an electron emission portion in a concave portion surrounded from three sides by one thick signal electrode, and further surrounded from one side by an adjacent signal electrode, in the position lower than the height of the signal electrode is explained with reference to FIG. 17A to FIG. 29B. As the fabricating method is same as that in the first embodiment, only different points are explained briefly.

First, as shown in FIGS. 3A-3C of the first embodiment, a metal film for the signal electrode 21 is formed on the glass substrate 10. After the film formation, the signal electrode 21 is formed by the patterning process, the etch process, and the like (FIGS. 17A-17C). In the case of a photosensitive printing film, the signal electrode 21 is formed by printing, exposure, and development. This signal electrode 21 is processed into a concave dent shape or U-shape in A-A′ direction in FIG. 17A so as to surround an electron emitter portion described below from three sides, and an electron emitter is formed in the gap part between this signal electrode 21 and the adjacent signal electrode 21.

Thereby, the process to form the electron emitter on the thick signal electrode 21 with bad flatness becomes unnecessary, and it is possible to form the base electrode 11 of the electron emitter directly on the interlayer insulator 15 or the glass substrate 10 by a process described below. Moreover, since the thick signal electrode 21 is formed so as to surround the electron emission portion from four sides in the horizontal direction (the scan line direction, the A-A′ direction), and in the vertical direction (the signal line direction, the B-B′ direction), it becomes a foundation which forms a concave electron lens for converging electron beams.

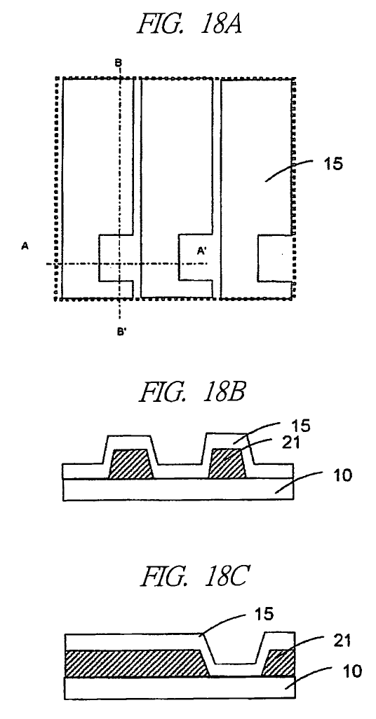

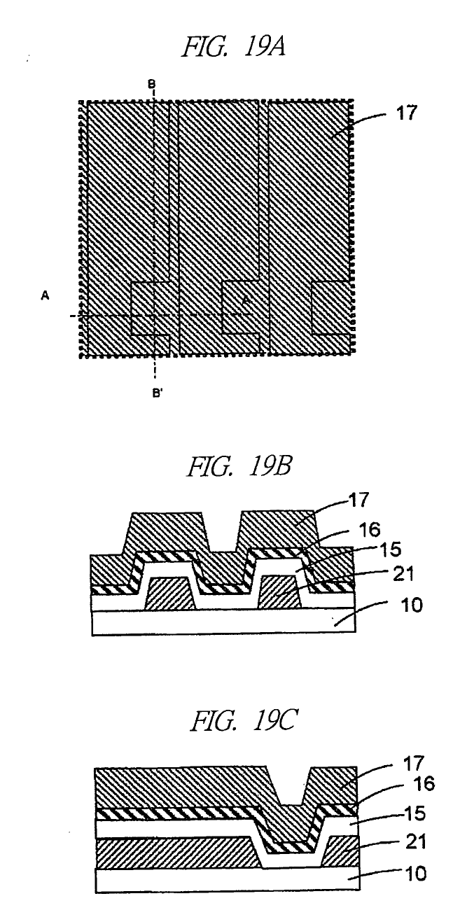

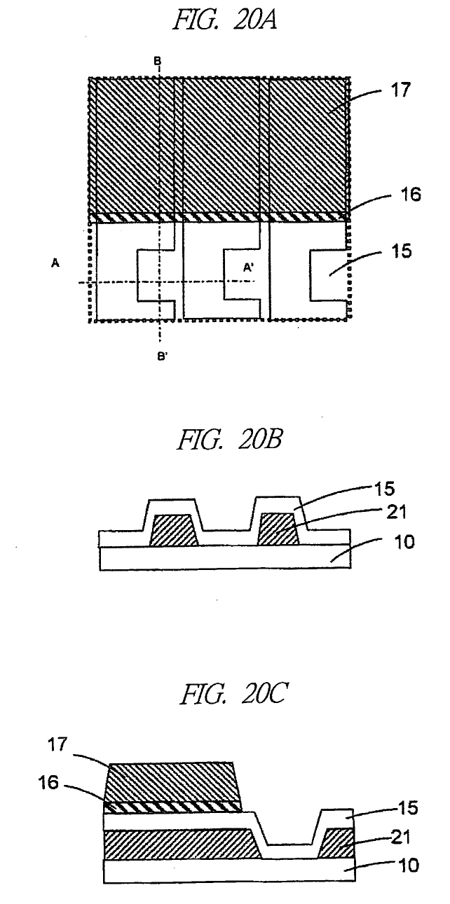

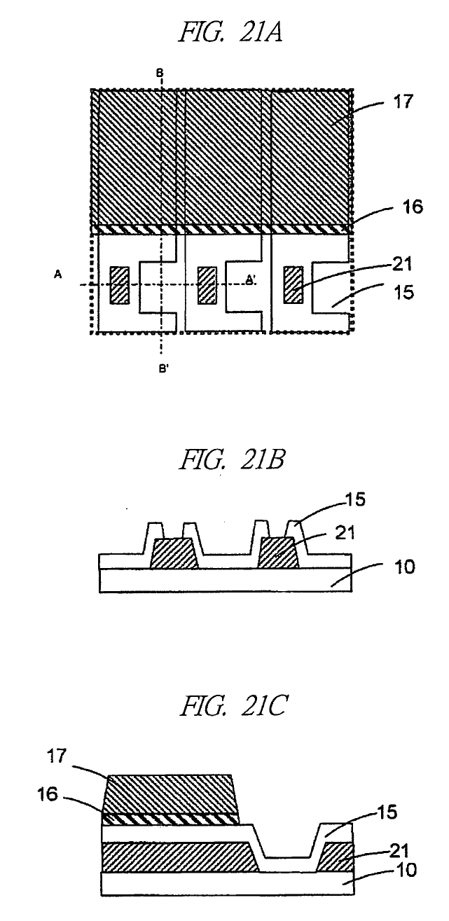

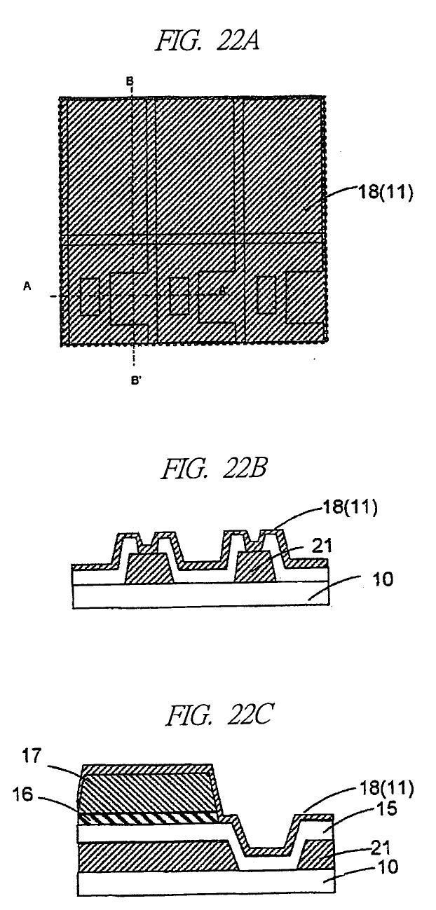

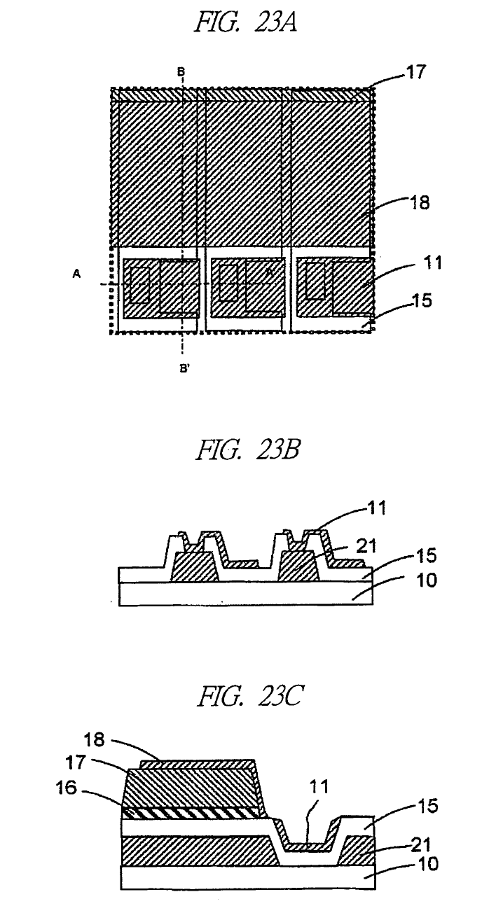

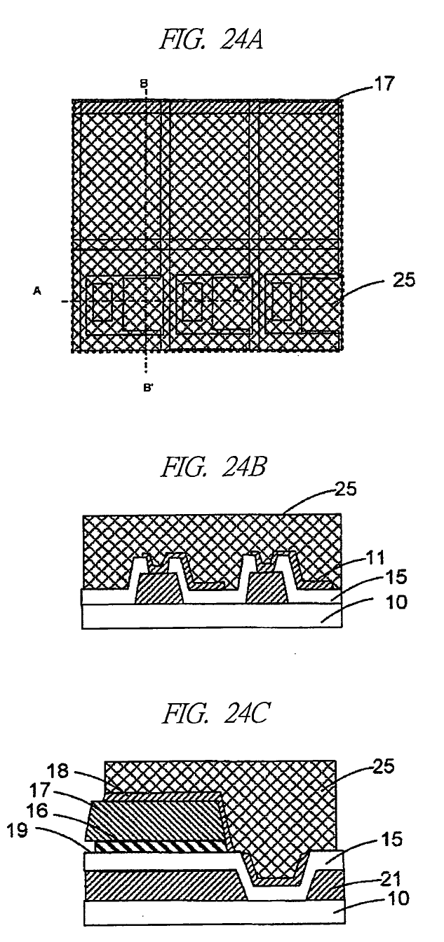

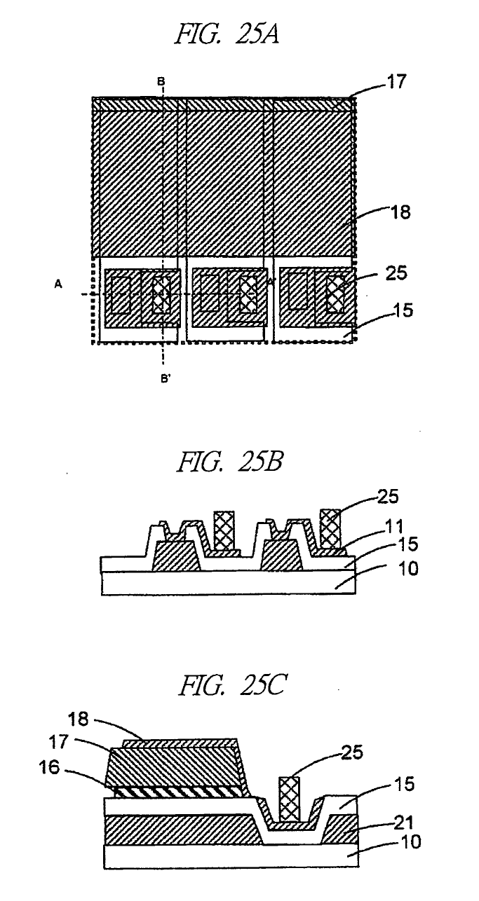

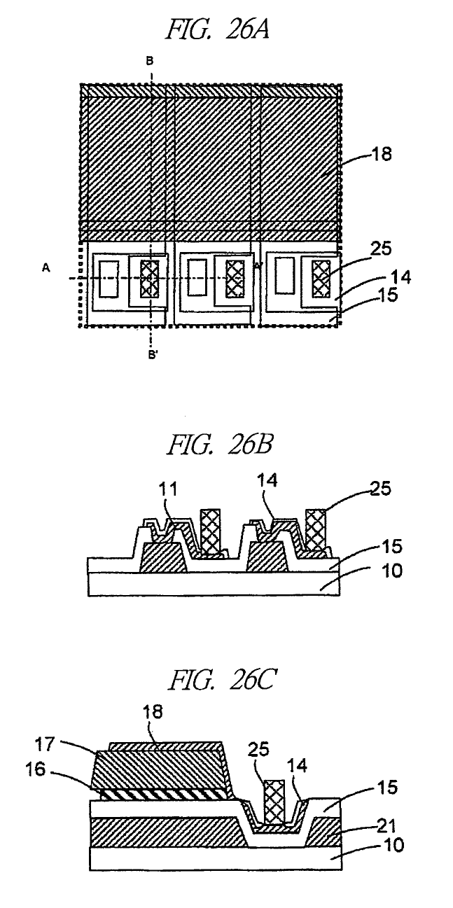

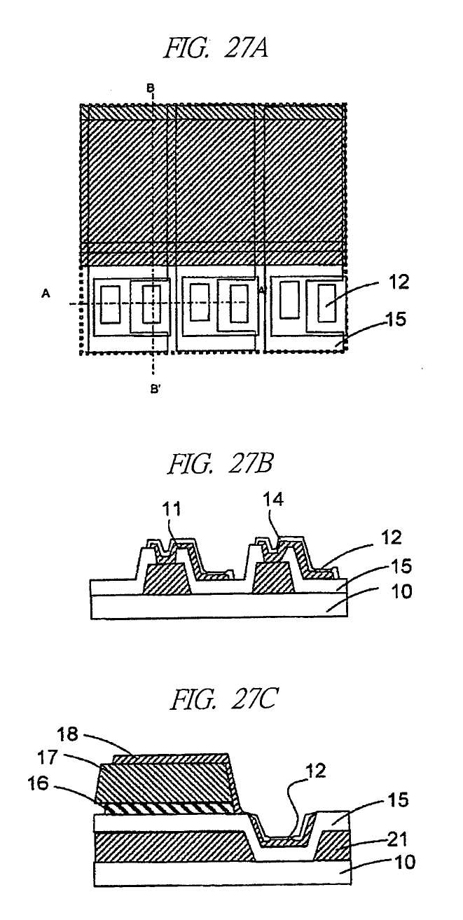

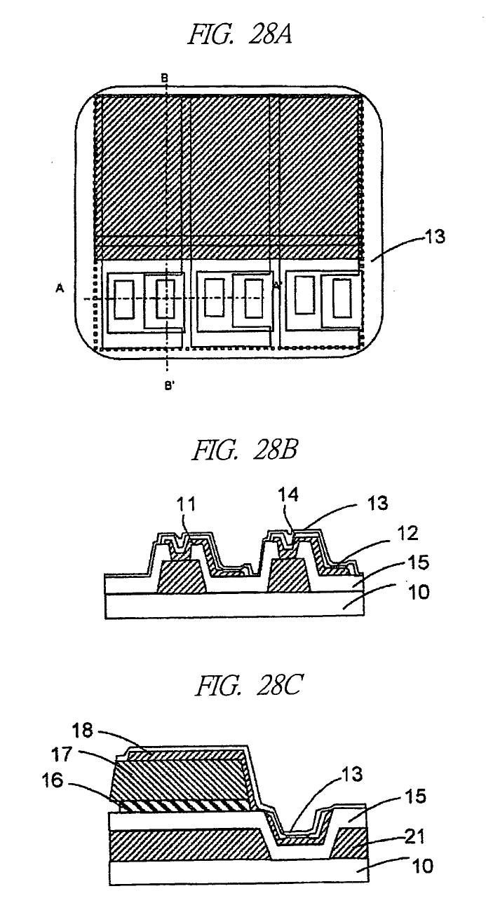

The fabricating method hereafter shown in the FIG. 18A to FIG. 28C is same as that in the first embodiment. FIGS. 18A-18C show the film formation or printing of the interlayer insulator 15; FIGS. 19A-19C show the film formation of the metal films for the isolation layer 16 and for scan electrode 17; FIGS. 20A-20C show a bulk processing of the scan electrode 17 and the isolation layer 16; FIGS. 21A-21C show the formation of a through hole of the interlayer insulator 15; FIGS. 22A-22C show the film formation of Al—Nd alloy film for the contact electrode 18 and for base electrode 11; FIGS. 23A-23C show the separation processing of the contact electrode 18 and the base electrode 11; FIGS. 24A-24C show the formation of the step separation part 19; FIGS. 25A-25C show the patterning of the electron emission portion; FIGS. 26A-26C show the anodization of the field insulation film or field insulator 14; FIGS. 27A-27C show the formation of the electron acceleration layer 12; and FIGS. 28A-28C show the film formation of the top electrode 13 (electron emission electrode).

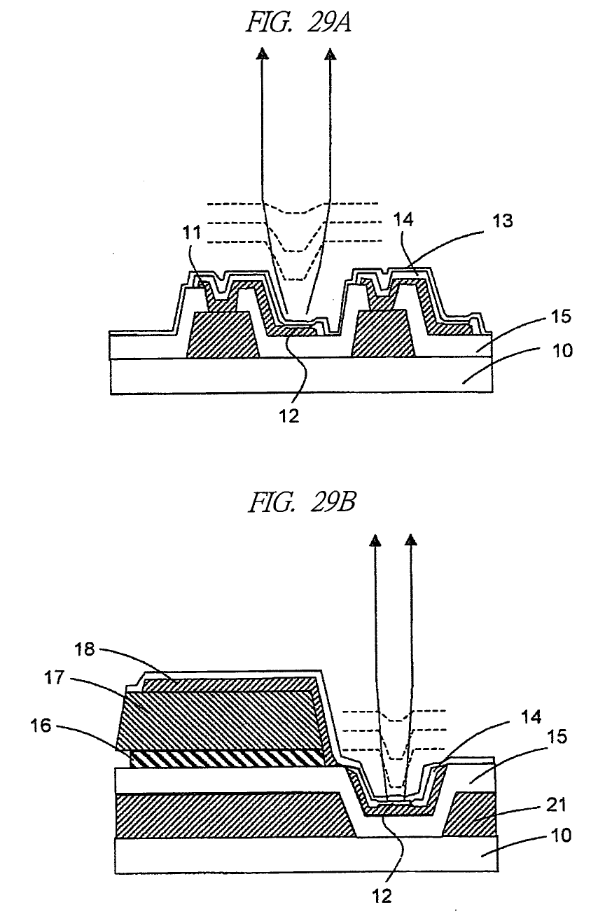

According to the present embodiment, by making the form to surround the electron acceleration layer 12 by the thick signal electrode 21 without using the interlayer insulator and the like for insulating the focusing electrode and the focusing electrode for exclusive use, it is possible to form the electron lens having a concave equipotential surface on the electron acceleration layer. The focusing performance of the electron beams to be emitted in the horizontal direction (the scan line direction, the A-A′ direction) and the focusing performance of the electron beams to be emitted in the vertical direction (the signal electrode direction, the B-B′ direction) can be improved, and the emission of multi colors and the flowing of the electron beam into the spacer 30 disposed on the scan electrode 17 can be prevented, and a high definition image display apparatus can be realized. The state where the anode electric field is modulated by the electron emitter of the present invention, and the orbit of the electron beams are schematically shown in FIGS. 29A and 29B.

### Third Embodiment

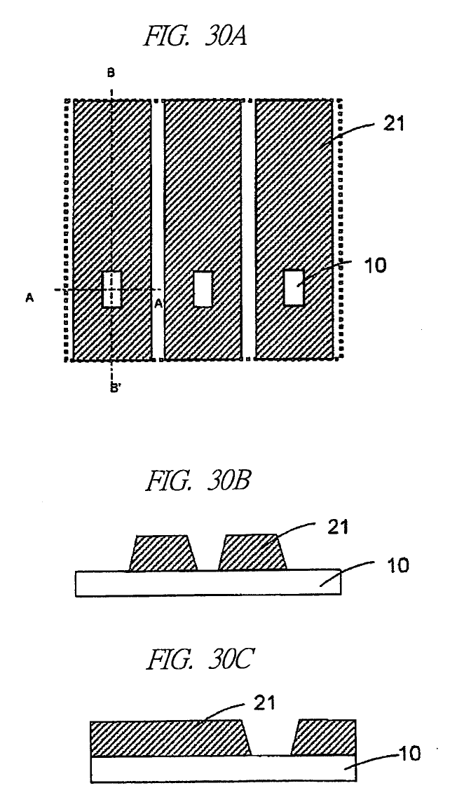

Hereinafter, an embodiment of the electron emitter array in which an electron emitter having an electron emission portion in a concave portion surrounded from four sides by one thick signal electrode, in the position lower than the height of the signal electrode 21 is explained with reference to FIG. 30A to FIG. 40. As the fabricating method is same as that in the first embodiment, only different points are explained briefly.

First, as shown in FIGS. 3A-3C of the first embodiment, a metal film for the signal electrode 21 is formed on the glass substrate 10. After the film formation, the signal electrode 21 in a line shape is formed by the patterning process, and the etch process (FIGS. 30A-30C). This signal electrode 21 is processed into a shape to have an opening therein so as to surround an electron emitter portion described below from four sides, and an electron emitter is formed in this opening.

Thereby, the process to form the electron emitter on the thick signal electrode 21 with bad flatness becomes unnecessary, and it is possible to form the base electrode 11 of the electron emitter directly on the interlayer insulator 15 or the glass substrate 10 by a process described below. Moreover, the thick signal electrode 21 is formed so as to surround the electron emission portion from four sides in the horizontal direction (the scan line direction, the A-A′ direction), and in the vertical direction (the signal line direction, the B-B′ direction), therefore it becomes a foundation which forms a concave electron lens for converging electron beams.

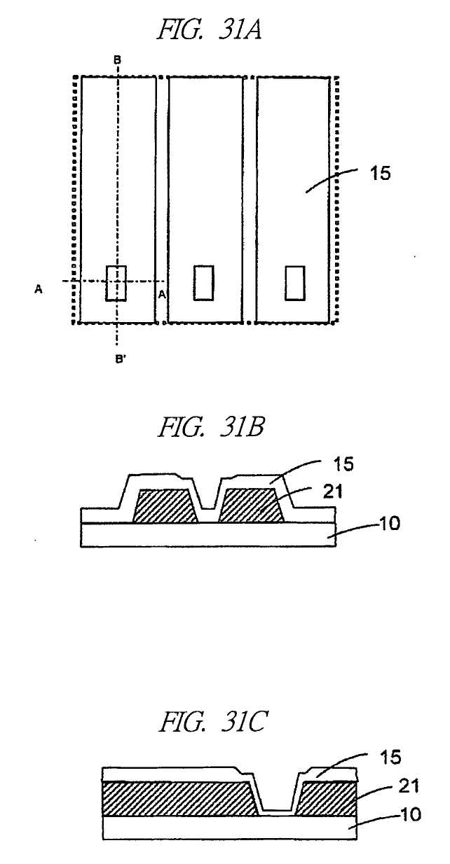

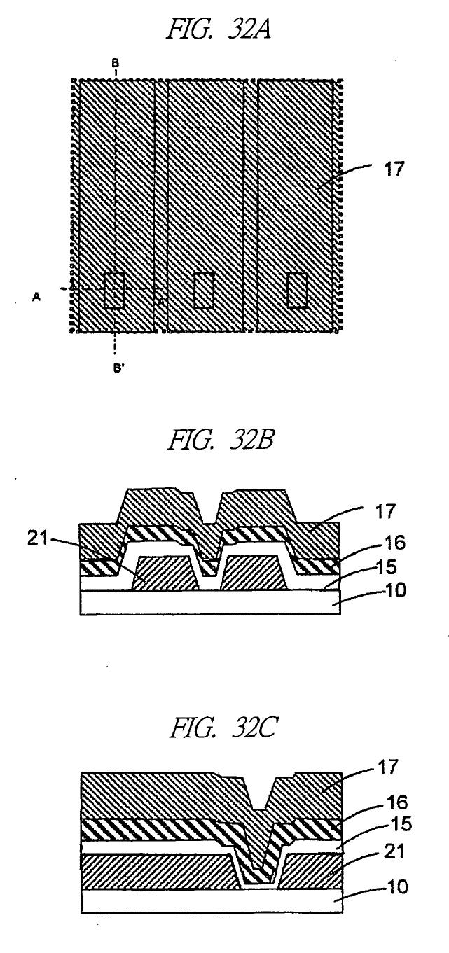

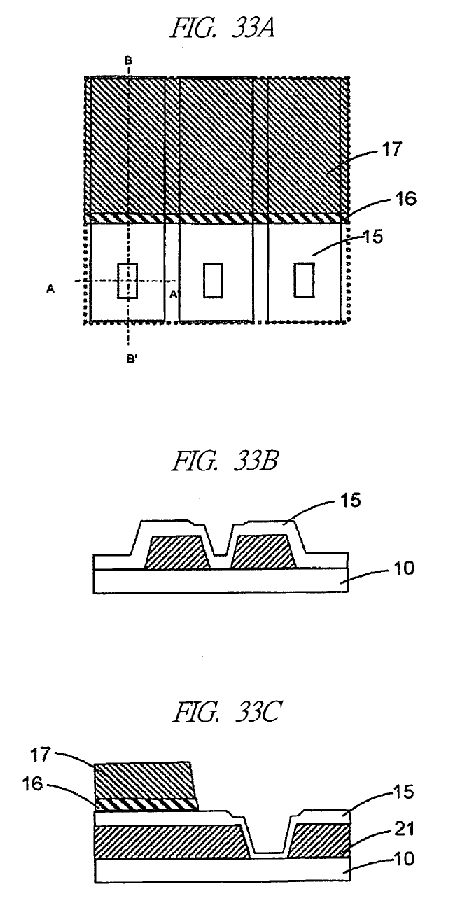

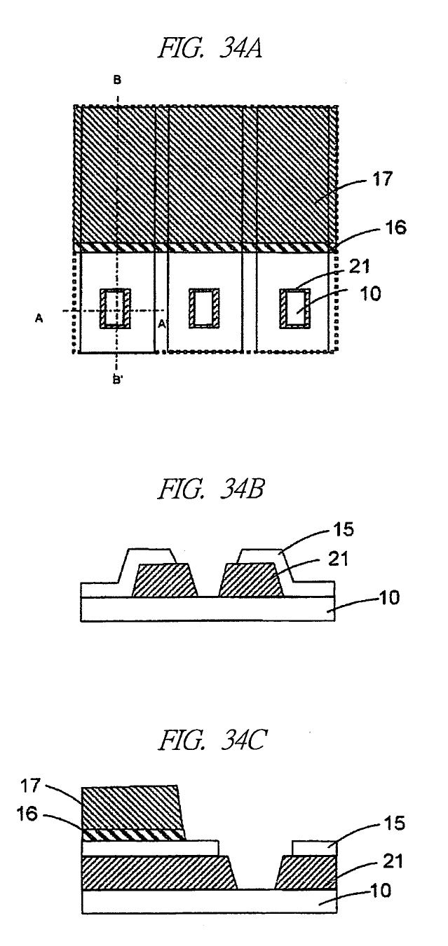

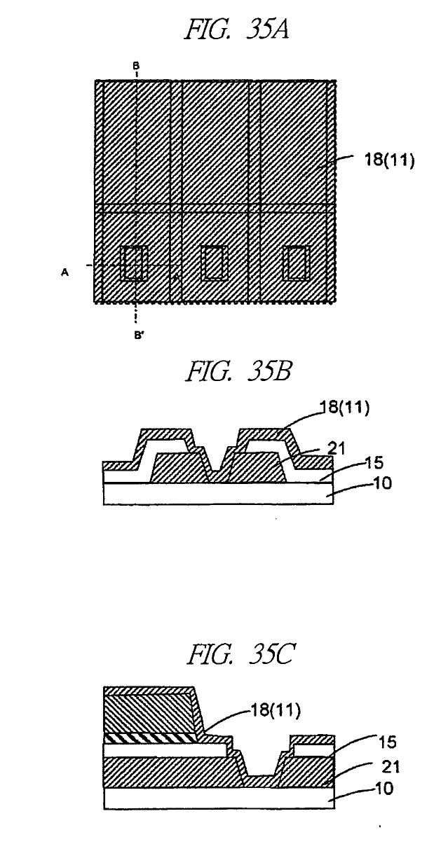

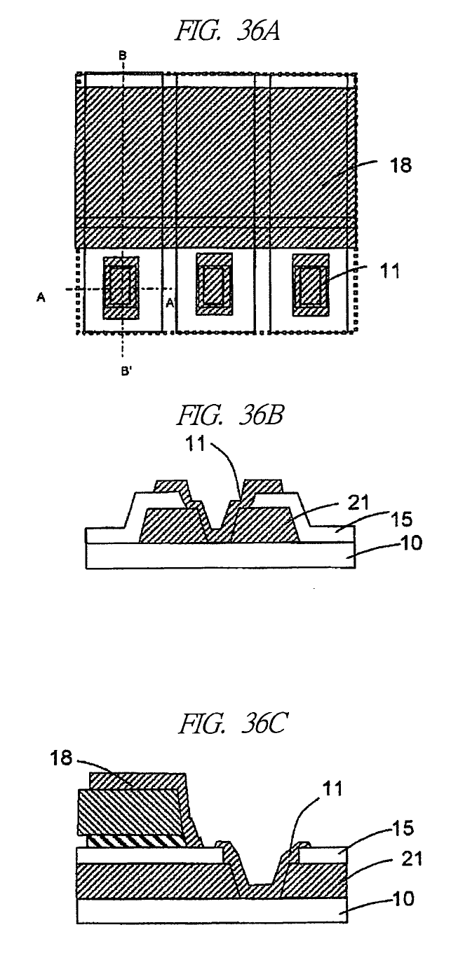

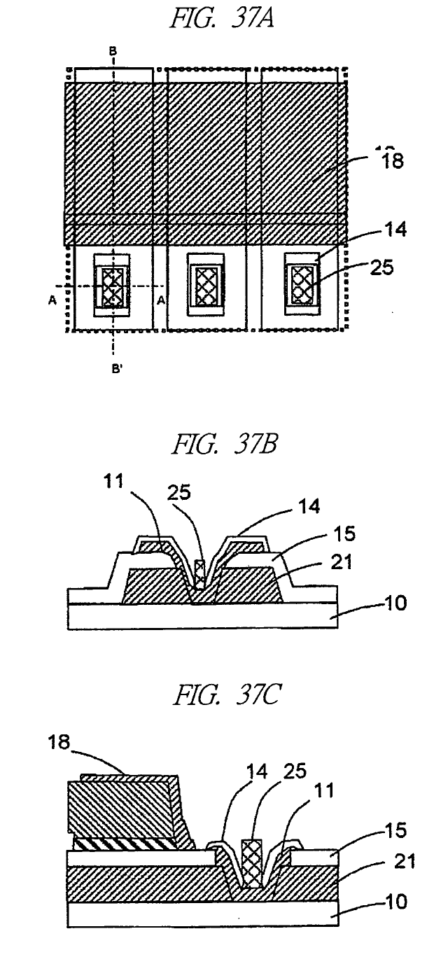

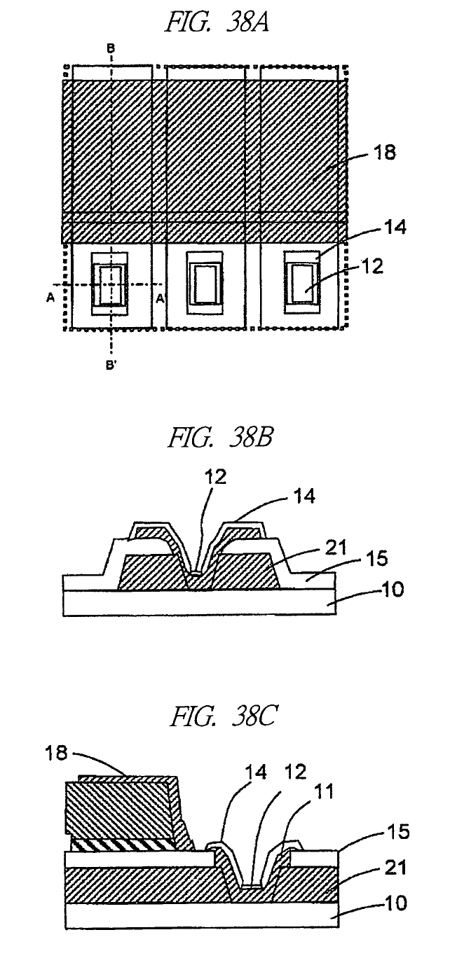

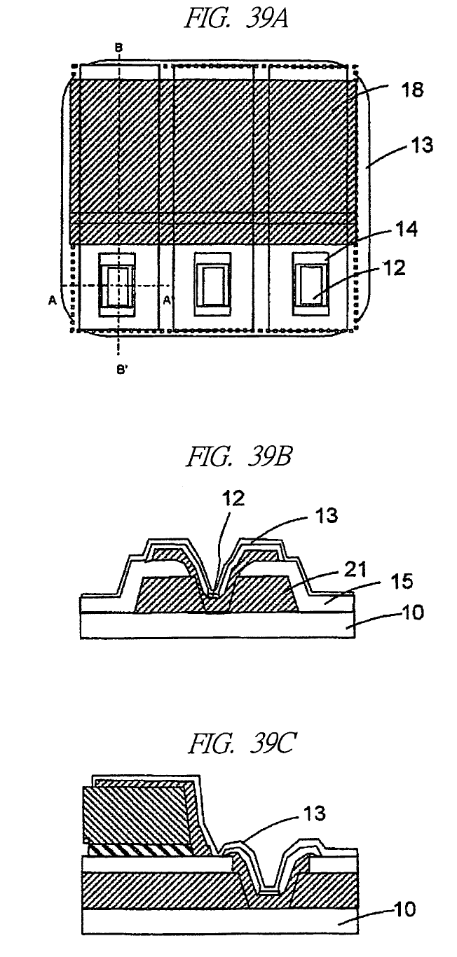

Hereinafter, the fabricating method shown in the FIG. 31A to FIG. 39C is same as that in the first embodiment. FIGS. 31A-31C show the film formation or printing of the interlayer insulator 15; FIGS. 32A-32C show the film formation of the metal films for the isolation layer 16 and for scan electrode 17; FIGS. 33A-33C show a bulk processing of the scan electrode 17 and the isolation layer 16; FIGS. 34A-34C show the formation of a through hole of the interlayer insulator 15; FIGS. 35A-35C show the film formation of Al—Nd alloy film for the contact electrode 18 and for base electrode 11; FIGS. 36A-36C show the separation processing of the contact electrode 18 and the base electrode 11 and the formation of the step separation part 19; FIGS. 37A-37C show the patterning of the electron emission portion and the anodization of the field insulation film or field insulator 14; FIGS. 38A-38C show the anodization of the electron acceleration layer 12, and FIGS. 39A-39C show the film formation of the top electrode 13 (electron emission electrode). However, in the present third embodiment, as shown in FIGS. 34A-34C, the through hole is formed so as to surround the opening of the signal electrode 21, and the electron emitter is formed not on the interlayer insulator 15 but on the glass substrate 10.

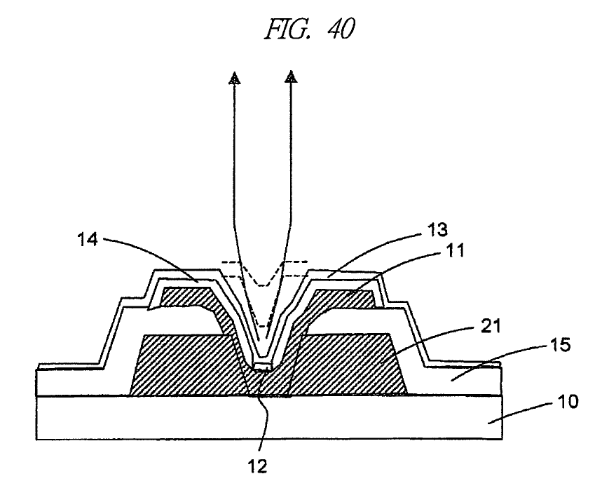

According to the present embodiment, by making the form to surround the electron acceleration layer 12 by the thick signal electrode 21 without using the focusing electrode for exclusive use and the interlayer insulator for insulating the focusing electrode, it is possible to form the electron lens having a concave equipotential surface on the electron acceleration layer. Then, the focusing performance of the electron beams to be emitted in the horizontal direction (the scan line direction, the A-A′ direction) and the focusing performance of the electron beams to be emitted in the vertical direction (the signal electrode direction, the B-B′ direction) can be improved. And the emission of multi colors can be prevented, and the electron beams are prevented from flowing into the spacer 30 disposed on the scan electrode 17, and a high definition image display apparatus can be realized. The state where the anode electric field is modulated by the electron emitter of the present invention, and the orbit of the electron beams are schematically shown in FIG. 40.

### Fourth Embodiment

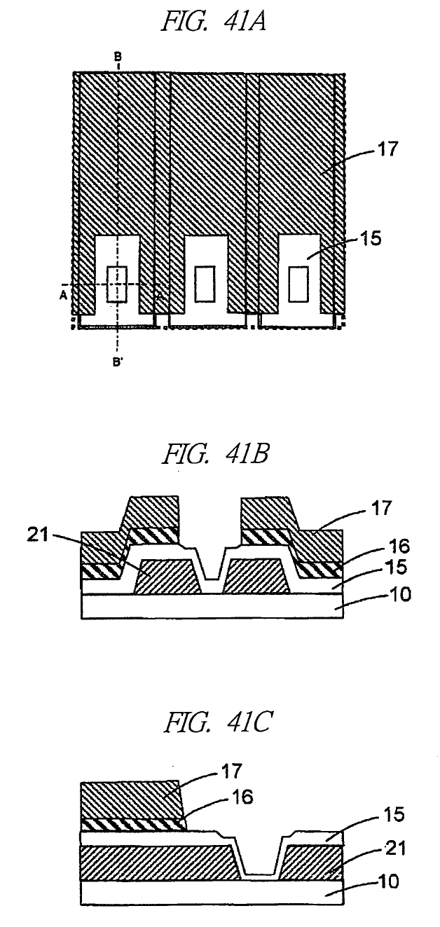

Hereinafter, a fourth embodiment of the electron emitter array in which an electron emitter having an electron emission portion in a concave portion surrounded from four sides by one thick signal electrode, and further surrounded from at least three sides by the scan electrode, in the position lower than the height of the signal electrode is explained with reference to FIG. 41A to FIG. 47C. As the fabricating method is same as that in the third embodiment, only different points are explained briefly.

First, the processes to the film formation of the scan electrode 17 are performed in the same manner as shown in FIGS. 32A-32C in the third embodiment. Next, the processing of the scan electrode 17 and the isolation layer 16 is performed (FIGS. 41A-41C). As for the etching, bulk etching may be performed by using wet etching with the mixed aqueous solution of phosphoric acid, acetic acid, and nitric acid. Here, the scan electrode is processed into the form to surround the electron acceleration layer from three sides. Thereby, it is possible to form a concave electron lens on the electron acceleration layer also by the scan electrode, and it becomes possible to further increase the focusing performance of the electron beams.

### Fifth Embodiment

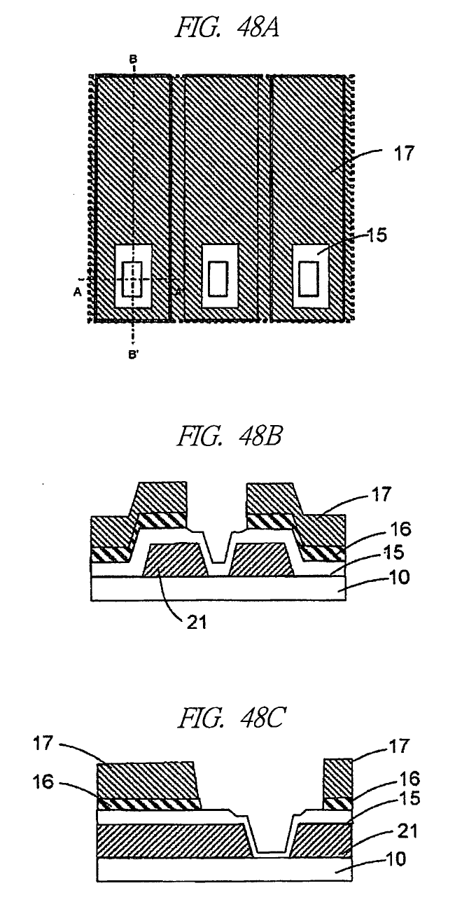

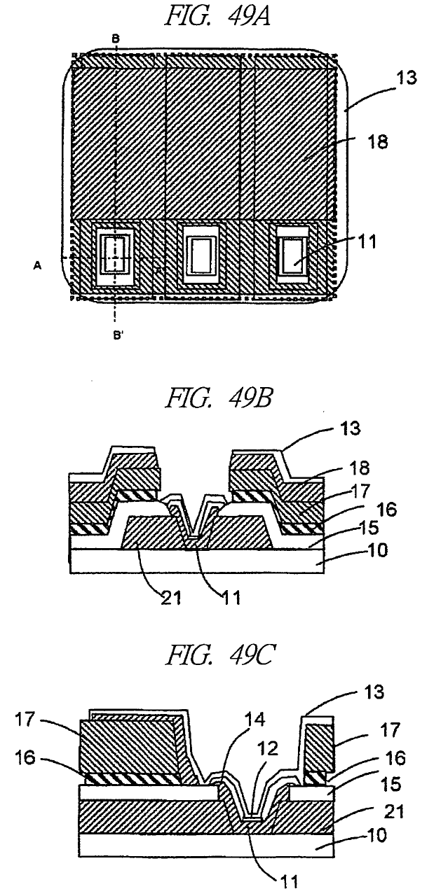

In a fifth embodiment, the scan electrode in the fourth embodiment is processed into the form to surround the electron acceleration layer from four sides, as shown in FIGS. 48A-48C. FIGS. 49A-49C are drawings for explaining the fabricating method of the fifth embodiment.

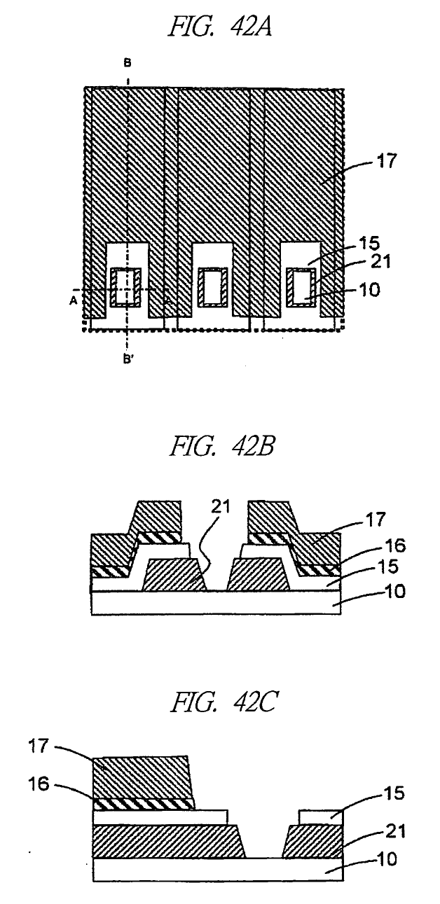

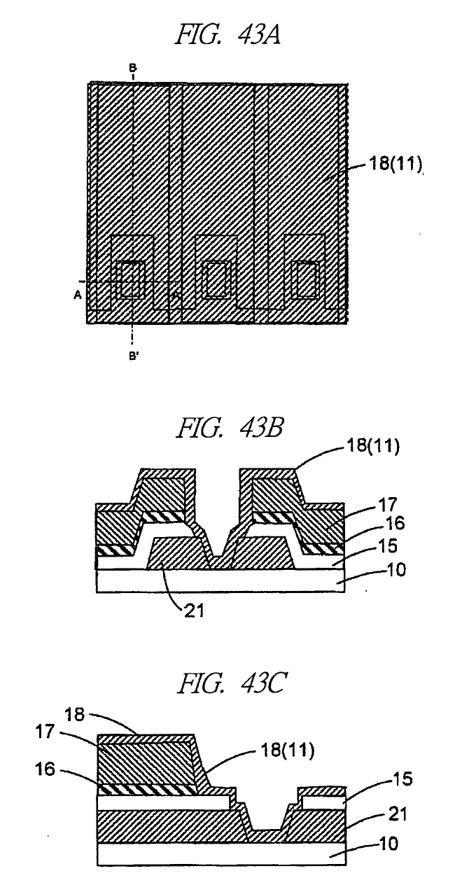

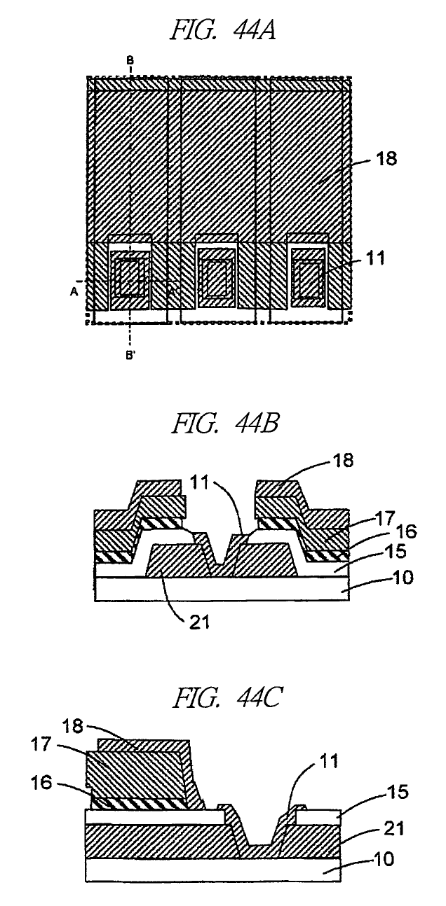

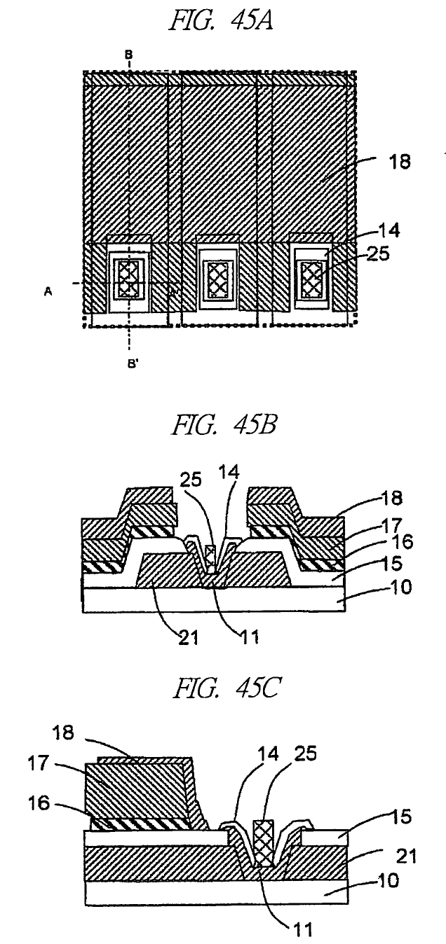

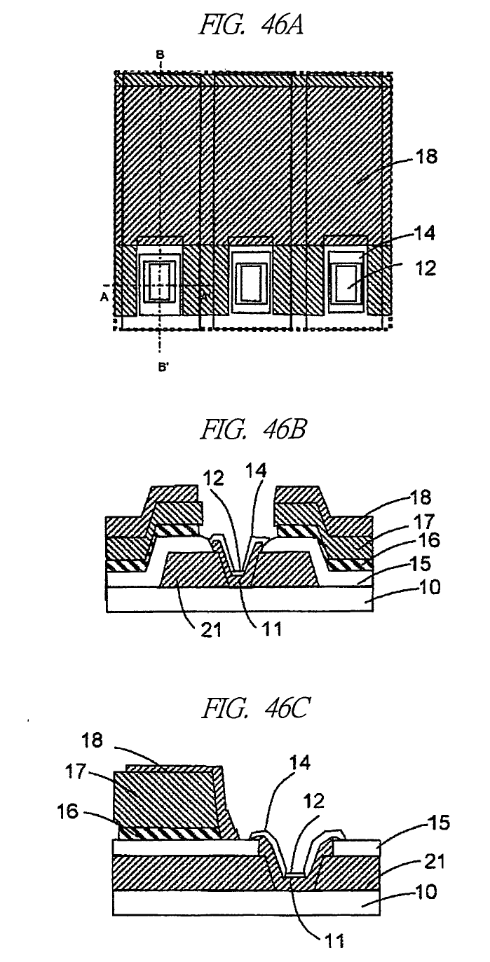

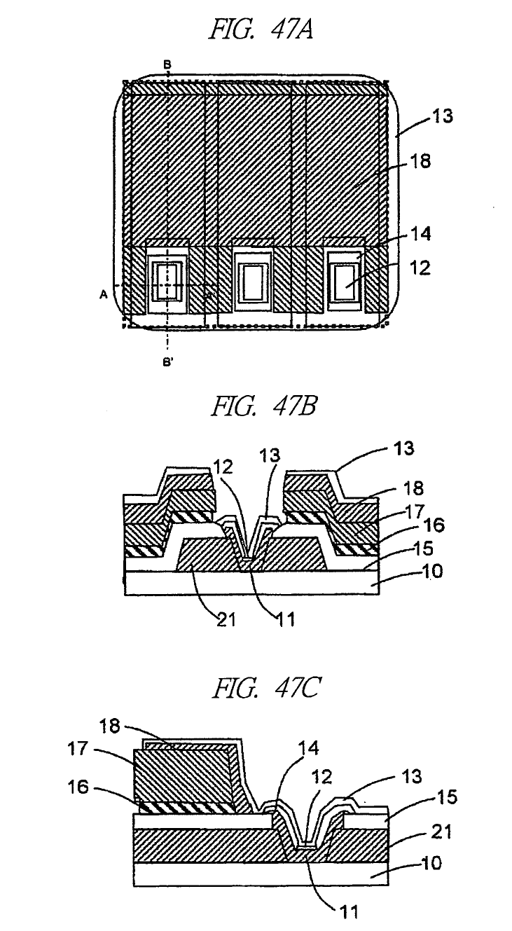

The fabricating method according to the fourth embodiment shown in the FIG. 42A to FIG. 47C and the fifth embodiment shown in FIGS. 49A-49C are same as that of the third embodiment. FIGS. 42A-42C show the formation of a through hole of the interlayer insulator 15; FIGS. 43A-43C show the film formation of Al—Nd alloy film for the contact electrode 18 and for base electrode 11; FIGS. 44A-44C show the separation processing of the contact electrode 18 and the base electrode 11 and the formation of the step separation part 19; FIGS. 45A-45C show the patterning of the electron emission portion and the anodization of the field insulation film 14; FIGS. 46A-46C show the anodization of the electron acceleration layer 12; and FIGS. 47A-47C show the film formation of the top electrode 13 (electron emission electrode).

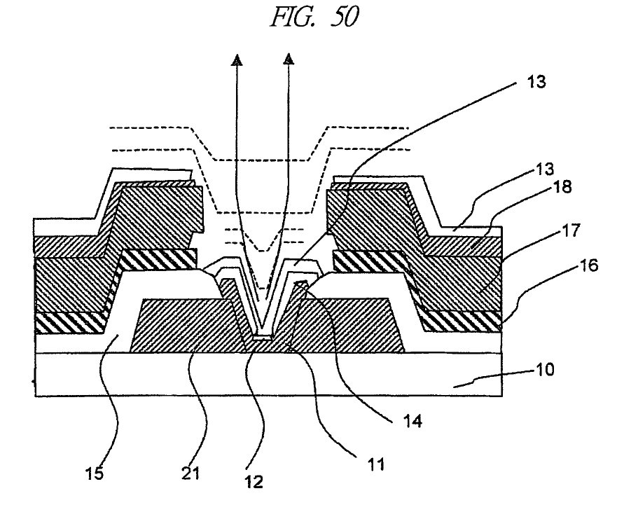

According to the fourth or fifth embodiment, the form to surround the electron acceleration layer 12 by the thick signal electrode 21 and the scan electrode 17 can be obtained without using the focusing electrode for exclusive use and the interlayer insulator for insulating the focusing electrode. It is possible to form the electron lens having a concave equipotential surface on the electron acceleration layer 12, and the focusing performance of the electron beams to be emitted in the horizontal direction (the scan line direction, the A-A′ direction) can be improved, and the emission of multi colors can be prevented. Thereby, a high definition image display apparatus can be realized. The state where the anode electric field is modulated by the electron emitter of the present invention, and the orbit of the electron beams are schematically shown in FIG. 50.

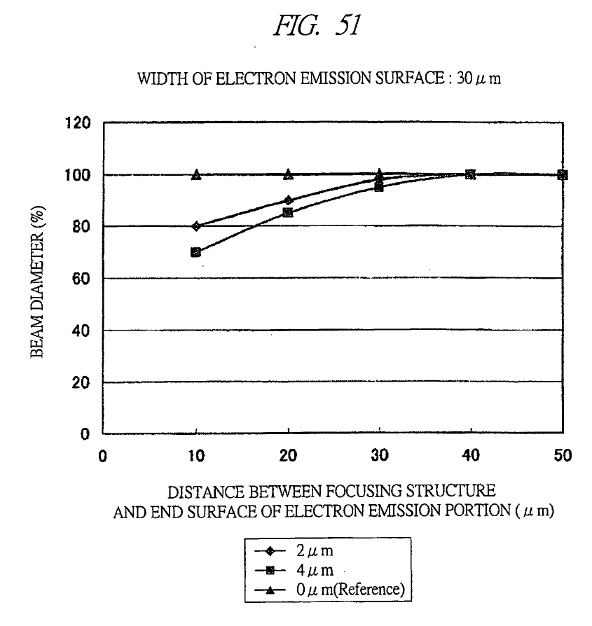

Finally, the result of the evaluation on the electron beam focusing performance is shown in FIG. 51. The focusing performance of the electron beams is dependent on the distance between the end surface of the electron emission portion and the focusing structure (the step of the signal electrode 21 or the scan electrode 17), and the difference between the focusing structure and the height of the electron emission portion. As seen from FIG. 51, the shorter the distance is and the larger the difference of height is, the more the effect to obtain the sufficient focusing performance is acquired, and it is preferable that the distance is set 20 μm or less and the difference of the height is 2 μm or more. Moreover, when the concave portion is surrounded doubly by scan electrode 17, it is preferable that the height of the scan electrode is set to 2 μm or more, and the distance from the end surface of the electron emission portion of the scan electrode 17 to the end surface of the electron emission portion of the signal electrode 21 is set to 20 μm or less.

In the foregoing, the invention made by the inventors of the present invention has been concretely described based on the embodiments. However, it is needless to say that the present invention is not limited to the foregoing embodiments and various modifications and alterations can be made within the scope of the present invention.

What is claimed is:

1. An image display apparatus comprising,
an electron emitter array in which an electron emitter having an electron emission portion in a position lower than the height of the signal electrodes is disposed on a concave portion held by two thick signal electrodes formed on an insulation substrate, and
a phosphor screen which is excited to emit by projection of electrons emitted from the electron emitter array.

2. The image display apparatus according to claim 1, comprising,
the electron emitter in which the electron emitter which has an electron emission portion in a concave portion surrounded from three sides by one thick signal electrode, and further surrounded from remaining one side by an adjacent signal electrode, in the position lower than the height of the signal electrodes, and the phosphor screen which is excited to emit the light by projection of electrons emitted from the electron emitter array are disposed.

3. The image display apparatus according to claim 1, comprising,
the electron emitter in which the electron emitter which has an electron emission portion in a concave portion surrounded from four sides by one thick signal electrode, in the position lower than the height of the signal electrode, and the phosphor screen which is excited to emit the light by projection of electrons emitted from the electron emitter array are disposed.

4. The image display apparatus according to claim 1, wherein
the difference of the height of the signal electrodes and that of the electron emission portion is 2 μm or more, and the distance from the end surface of the electron emission portion of the scan electrode to the end surface of the electron emission portion of the signal electrode is 20 μm or less.

5. The image display apparatus according to any of claim 1, wherein
the concave portion is surrounded from three sides doubly by a thick scan electrode insulated from the signal electrode by an interlayer insulator, and
further comprising, the electron emitter array in which the above electron emitter which has the above electron emission portion is disposed in a position lower than the height of the above signal electrode, and a phosphor screen which is excited by projection of electrons emitted from the electron emitter array and emits light is disposed.

6. The image display apparatus according to one of claim 1, wherein
the concave portion is held, or surrounded by a thick film signal electrode formed on the above insulation substrate, and further surrounded doubly from four sides of the above thick film scan electrode insulated from the signal electrode by an interlayer insulator, and
further comprising, the electron emitter array in which the above electron emitter which has the above electron emission portion is disposed in a position lower than the height of the above signal electrode, and a phosphor screen which is excited by projection or bombardment of electrons emitted from the electron emitter array and emits light is disposed.

7. The image display apparatus according to claim 1, wherein
the height of the scan electrode is 2 μm or more, and the distance from the end surface of the electron emission portion of the scan electrode to the end surface of the electron emission portion of the signal electrode is set 20 μm or less.

8. The image display apparatus according to claim 1, wherein the electron emitter is the one which emits electrons by applying a voltage between two thin film electrodes that are connected to the thick signal electrode and the scan electrode insulated by the interlayer insulator respectively and are thinner than the signal electrode and the scan electrode.

9. The image display apparatus according to claim 8, wherein
the two thin film electrodes are formed by separately processing a same metal film formed as the upper layer than the signal electrode and the scan electrode.

10. The image display apparatus according to claim 8, wherein
the electron emitter has a structure in which an electron acceleration layer where an insulator or a semiconductor layer and the like are laminated on one thin film electrode connected to the signal electrode of the two thin film electrodes, and an electron emission electrode are laminated on the other thin film electrode connected to the scan electrode.

11. The image display apparatus according to claim 8, wherein
the electron emitter has a structure in which an electron acceleration layer where the surface of the thin film electrode connected to the signal electrode of the two thin film electrodes is oxidized, and an electron emission electrode are laminated on the other thin film electrode connected to the scan electrode.

12. The image display apparatus according to claim 1, wherein
the signal electrode is made of an Al alloy.

13. The image display apparatus according to claim 1, wherein
the signal electrode is made of Al.

14. The image display apparatus according to claim 1, wherein
the signal electrode is a printed wiring that is made mainly of Ag.

15. The image display apparatus according to claim 8, wherein
the thin film electrode is made of an Al alloy

16. The image display apparatus according to claim 11, wherein
the electron acceleration layer is formed by anodizing the Al alloy.

17. The image display apparatus according to claim 8, wherein
the addition element concentration of the Al alloy of the thin film electrode is lower than that of the signal electrode of the thick film.

18. The image display apparatus according to claim 11, wherein the electron acceleration layer in which the surface of the thin film electrode is oxidized is formed by anodizing the thin film electrode whose addition element concentration is lower than that of the signal electrode of the thick film.
